(19) United States
(12) Patent Application Publication
(10) Pub. No.: US 2025/0184510 A1
(43) Pub. Date: Jun. 5, 2025

(54) METHOD FOR DECODING VIDEO FROM VIDEO BITSTREAM REPRESENTING VIDEO

(71) Applicant: GUANGDONG OPPO MOBILE TELECOMMUNICATIONS CORP., LTD., Dongguan, Guangdong (CN)

(72) Inventors: Kazushi SATO, Palo Alto, CA (US); Yue YU, Palo Alto, CA (US); Haoping YU, Palo Alto, CA (US)

(21) Appl. No.: 18/843,984

(22) PCT Filed: Mar. 9, 2023
(86) PCT No.: PCT/US2023/064052

§ 371 Date: Sep. 4, 2024

Related U.S. Application Data
(60) Provisional application No. 63/269,090, filed on Mar. 9, 2022.
(60) Provisional application No. 63/366,218, filed on Jun. 10, 2022.
(60) Provisional application No. 63/367,710, filed on Jul. 5, 2022.
(60) Provisional application No. 63/368,240, filed on Jul. 12, 2022.
(60) Provisional application No. 63/363,703, filed on Apr. 27, 2022.

(51) Int. Cl. H04N 19/44; H04N 19/13; H04N 19/169; H04N 19/174; H04N 19/70; H04N 19/91

(52) U.S. Cl. CPC H04N 19/44; H04N 19/13; H04N 19/174; H04N 19/1883; H04N 19/70; H04N 19/91

(57) ABSTRACT

A method for decoding a video from a video bitstream representing the video, the method includes: accessing a binary string from the video bitstream, the binary string representing a slice of a frame of the video; determining an initial context value of an entropy coding model for the slice to be one of a first context value stored for a first CTU in a previous slice of the slice, a second context value stored for a second CTU in the previous slice, and a default initial context value independent of the previous slice; decoding the slice by decoding at least a portion of the binary string according to the entropy coding model with the initial context value; reconstructing the frame of the video based, at least in part, upon the decoded slice; and causing the reconstructed frame to be displayed along with other frames of the video.

### CROSS-REFERENCE TO RELATED APPLICATIONS

This application is a national stage entry under 35 U.S.C. § 371 of International Application No. PCT/US2023/064052, filed Mar. 9, 2023, which claims priority to U.S. Provisional Application No. 63/269,090, entitled “Entropy Coding Method,” filed on Mar. 9, 2022, U.S. Provisional Application No. 63/363,703, entitled “Entropy Coding Method,” filed on Apr. 27, 2022, U.S. Provisional Application No. 63/366,218, entitled “Entropy Coding Method,” filed on Jun. 10, 2022, U.S. Provisional Application No. 63/367,710, entitled “Entropy Coding Method,” filed on Jul. 5, 2022, U.S. Provisional Application No. 63/368,240, entitled “Entropy Coding Method,” filed on Jul. 12, 2022. The entire disclosures of the above-identified applications are hereby incorporated herein by reference.

### TECHNICAL FIELD

This disclosure relates generally to video processing. Specifically, the present disclosure involves a method for decoding a video from a video bitstream representing the video.

### BACKGROUND

The ubiquitous camera-enabled devices, such as smartphones, tablets, and computers, have made it easier than ever to capture videos or images. However, the amount of data for even a short video can be substantially large. Video coding technology (including video encoding and decoding) allows video data to be compressed into smaller sizes thereby allowing various videos to be stored and transmitted. Video coding has been used in a wide range of applications, such as digital TV broadcast, video transmission over the Internet and mobile networks, real-time applications (e.g., video chat, video conferencing), DVD and Blu-ray discs, and so on. To reduce the storage space for storing a video and/or the network bandwidth consumption for transmitting a video, it is desired to improve the efficiency of the video coding scheme.

### SUMMARY

In one example, a method for decoding a video from a video bitstream representing the video includes accessing a binary string from the video bitstream, the binary string representing a slice of a frame of the video; determining an initial context value of an entropy coding model for the slice to be one of a first context value stored for a first CTU in a previous slice of the slice, a second context value stored for a second CTU in the previous slice, and a default initial context value independent of the previous slice; decoding the slice by decoding at least a portion of the binary string according to the entropy coding model with the initial context value; reconstructing the frame of the video based, at least in part, upon the decoded slice; and causing the reconstructed frame to be displayed along with other frames of the video.

In one example, a method for decoding a video from a video bitstream representing the video includes accessing a binary string from the video bitstream, the binary string representing a partition of the video; determining an initial context value of an entropy coding model for the partition by converting a context value stored for a CTU in a previous partition of the partition based on an initial context value associated with the previous partition, a slice quantization parameter of the previous partition, and a slice quantization parameter of the partition; decoding the partition by decoding at least a portion of the binary string according to the entropy coding model with the initial context value; reconstructing frames of the video based, at least in part, upon the decoded partition; and causing the reconstructed frames to be displayed.

In one example, a method for decoding a video from a video bitstream representing the video includes accessing a binary string from the video bitstream, the binary string representing a partition of a frame of the video; determining an initial context value for an entropy coding model for the partition by converting a context value stored in a buffer for a CTU in a previous frame of the frame based on an initial context value associated with the previous frame, a slice quantization parameter of the previous frame, and a slice quantization parameter of the frame; decoding the partition by decoding at least a portion of the binary string according to the entropy coding model with the initial context value; replacing the context value stored in the buffer with a context value for a CTU in the frame determined in decoding the partition; reconstructing the frame of the video based, at least in part, upon the decoded partition; and causing the reconstructed frame to be displayed.

### BRIEF DESCRIPTION OF THE DRAWINGS

Features, embodiments, and advantages of the present disclosure are better understood when the following Detailed Description is read with reference to the accompanying drawings.

FIG. 1 is a block diagram showing an example of a video encoder configured to implement embodiments presented herein.

FIG. 2 is a block diagram showing an example of a video decoder configured to implement embodiments presented herein.

FIG. 3 depicts an example of a coding tree unit division of a picture in a video, according to some embodiments of the present disclosure.

FIG. 4 depicts an example of context initialization from the previous frame (CIPF), according to some embodiments of the present disclosure.

FIG. 5 depicts another example of context initialization from a previous frame (CIPF), according to some embodiments of the present disclosure.

FIG. 6 depicts an example of a group of pictures structure for random access with the associated temporal layer indices, according to some embodiments of the present disclosure.

FIG. 7 depicts an example of a process for decoding a video encoded via entropy coding with adaptive context initialization, according to some embodiments of the present disclosure.

FIG. 8 shows an example of the motion compensation and entropy coding context initialization dependencies of a picture coding structure for random access common test condition applied with the context initialization using the previous frame.

FIG. 9 shows an example of the context initialization inheritance from the previous frame in the coding order regardless of temporal layer and quantization parameter for the example picture coding structure shown in FIG. 8, according to some embodiments of the present disclosure.

FIG. 10 shows an example of the context initialization inheritance from the previous frame in a lower temporal layer for the example picture coding structure shown in FIG. 8, according to some embodiments of the present disclosure.

FIG. 11 depicts an example of values involved in the context initialization table conversion, according to some embodiments of the present disclosure.

FIG. 12 depicts an example of a process for decoding a video encoded with the picture coding structure of random access via entropy coding with adaptive context initialization, according to some embodiments of the present disclosure.

FIG. 13 depicts an example of applying the context initialization using the previous frame (CIPF) to the low delay common test condition, according to some embodiments of the present disclosure.

FIG. 14 shows the behaviour of the CIPF buffers for the example shown in FIG. 8.

FIG. 15 shows another example of the random access (RA) test condition.

FIG. 16 shows the behaviour of the CIPF buffers for the example shown in FIG. 15.

FIG. 17 shows an example of the behaviour of the proposed CIPF buffer configuration for the RA test condition shown in FIG. 15, according to some embodiments of the present disclosure.

FIG. 18 depicts an example of a process for decoding a video encoded with the CIPF with adaptive context initialization and presented buffer management, according to some embodiments of the present disclosure.

FIG. 19 depicts an example of a computing system that can be used to implement some embodiments of the present disclosure.

### DETAILED DESCRIPTION

Various embodiments provide context initialization for entropy coding in video coding. As discussed above, more and more video data are being generated, stored, and transmitted. It is beneficial to increase the efficiency of the video coding technology. One way to do so is through entropy coding where an entropy encoding algorithm is applied to quantized samples of the video to reduce the size of data representing the video samples. In the context-based binary arithmetic entropy coding, the coding engine estimates a context probability indicating the likelihood of the next binary symbol having the value one. Such estimation requires an initial context probability estimate. One way to determine the initial context probability estimate is to use the context value for a CTU located in the center of the previous slice. However, such an initialization may not be accurate because it is likely that the previous slice does not have enough bits encoded in the context-based coding mode, and the context value of the CTU located in the center of the previous slice does not accurately reflect the context of the slice.

Various embodiments described herein address these problems by enabling adaptive context initialization. The adaptive context initialization allows the initial context value of an entropy coding model for a current slice to be chosen from multiple options based on the setting or configuration of the frame or the slice. For example, the initial context value can be set to the context value of a last CTU in the previous slice or frame, the context value of a CTU located in the center of the previous slice or frame, or a default initial context value independent of the previous slice or frame.

In one embodiment, a syntax element can be used to indicate the CTU location for obtaining the initial context value from the previous slice or frame. If the syntax element has a first value (e.g., 1), the initial context value can be set to the context value stored for the center CTU of the previous slice or frame; if the syntax element has a second value (e.g., 0), the initial context value can be set to the context value stored for the last CTU of the previous slice or frame. Another syntax element can be used to indicate whether to use the context value from the previous slice or frame for initialization or use the default initial context value. In some examples, both syntax elements can be transmitted in the picture header of the frame containing the slice or the slice header of the slice.

In a further embodiment, a syntax element indicating the threshold value for determining a CTU location for obtaining the initial context value from the previous slice or frame can be used. The quantization parameter (QP) value of the previous slice or frame can be compared with the threshold value. If the QP value is no higher than the threshold value, the initial context value can be set to be the context value of the center CTU of the previous slice or frame; and otherwise, the initial context value can be set to be the context value of the last CTU of the previous slice or frame.

In another embodiment, the initialization can be made based on the temporal layer indices associated with the frames in a group of pictures (GOP) structure for random access (RA). For example, two syntax elements can be used: a first syntax element indicating a first threshold value for determining whether to use the initial context value from the previous slice or frame and a second syntax element indicating a second threshold value for determining a CTU location for obtaining the initial context value from the previous slice or frame. The second threshold value is set to be no higher than the first threshold value. If the temporal layer index of the current slice is higher than the first threshold value, the initial context value for the slice is set to be the default initial context value. If the temporal layer index is no higher than the first threshold value, the temporal layer index of the slice is compared with the second threshold value. If the temporal layer index is no higher than the second threshold value, the initial context value is determined to be the context value of the center CTU of the previous slice or frame; otherwise, the initial context value is set to be the context value of the last CTU of the previous slice or frame.

When the CIPF is applied to the picture coding structure of random access, the initialization inheritance from previous slice or frame having the same slice quantization parameter may introduce additional dependencies between frames, which would limit parallel processing capability for both encoding and decoding. To solve this problem, the context initilization inheritance can be modified to eliminate these additional dependencies. For example, the context initilization for a current frame can be determined to be the context value of the previous frame in the coding order regardless of temporal layer and the slice quantizatoin parameter. In another example, the initial context value can be determined to be the context value of the previous frame in a lower temporal layer. In a further example, the initial context value can be determined to be the context value of the reference frame(s) of the current frame according to the motion compensation and prediction structure.

In addition, because the slice quantization parameters of the current picture and the picture to be inherited may be different, the inherited initial context value can be converted based on the previous slice quantization parameter and the current slice quantization parameter. In one example, the conversion is performed based on the default initial context value determined using the quantization parameter of the previous slice or frame and the default initial context value determined using the quantization parameter of the current slice or frame. In another example, the conversion is performed based on the initial context value of the previous slice or frame which may be determined using the same method described herein based on its previous slice or frame.

To use the context value from the previous frame or slice for CIPF purposes, a buffer is used to store the context value. The current CIPF uses 5 buffers to store context value and each buffer is used to store the context data for frames with a corresponding temporal layer index. However, frames with the same temporal layer index may have different slice quantizatoin parameters. Thus, each time a new combination of temporal layer index and slice quantization parameter is observed, the context value for the frame with the new combination is pushed into the buffer and old data in the buffer is discarded. As a result, the context value for previous frames, especially frames with low temporal layer indices, may be discarded, preventing the CIPF to be applied to the frames for which the coding gain can be obtained the most by applying the CIPF. This leads to a reduction in the coding efficiency.

To solve this problem, the CIPF buffers can be managed to keep a context value from each temporal layer in the buffers. As a result, the CIPF process can be applied to each eligible frame by using the context value stored in the buffer that has the same temporal layer index. After coding the current frame, the new context value will replace the existing context value in the buffer that has been used as the initial context value and has the same temporal layer index as the current frame. If the slice quantization parameters of the current frame and the previous frame are different, the stored context value can be converted based on the two slice quantization parameters before being used for the entropy coding model. Alternatively, the number of buffers can be increased to allow the context values for different slice quantization parameters at different temporal layers to be stored and used for frames with the corresponding temporal layer index and slice quantization parameter.

As described herein, some embodiments provide improvements in video coding efficiency by allowing adaptively selecting the context value initialization for the entropy coding model. Because the initial context value can be selected from the center CTU or the last CTU of the previous slice based on the configuration of the current slice or frame and/or the previous slice or frame, such as the slice QP and the temporal layer index, the initial context value can be selected more accurately. As a result, the entropy coding model is more accurate, leading to a higher coding efficiency.

Further, by allowing the initial context to be inherited from a slice or a frame having a different slice quantization parameter than the current slice quantization parameter, the additional dependencies among pictures introduced by the context initialization inheritance in the picture coding structure of random access can be eliminated thereby improving the parallel processing capability of the encoder and decoder. The inherited initial context value can be converted based on the quantization parameter of the previous slice or frame and the quantization parameter of the current slice. The conversion reduces or eliminates the inaccuracy in the initial context value estimation that is introduced by the difference between the slice quantization parameters of the current slice or frame and the previous slice or frame. As a result, the overall coding efficiency is improved.

The coding efficiency of the video is further improved by improving the buffer management to keep a context value for each temporal layer in the buffer. Further, by converting the context value based on the slice quantization parameters of the previous frame and the current frame, the same buffer can be used to score the context value for frames in a temporal layer with different slice quantization parameters. As a result, the total number of buffers remain unchanged and the CIPF can be performed for each qualifying frame. Compared with the existing buffer management where the data in the buffer may be lost rendering the CIPF unavailable for some frames, the proposed buffer management allows the CIPF to be applied to more frames to achieve a higher coding efficiency.

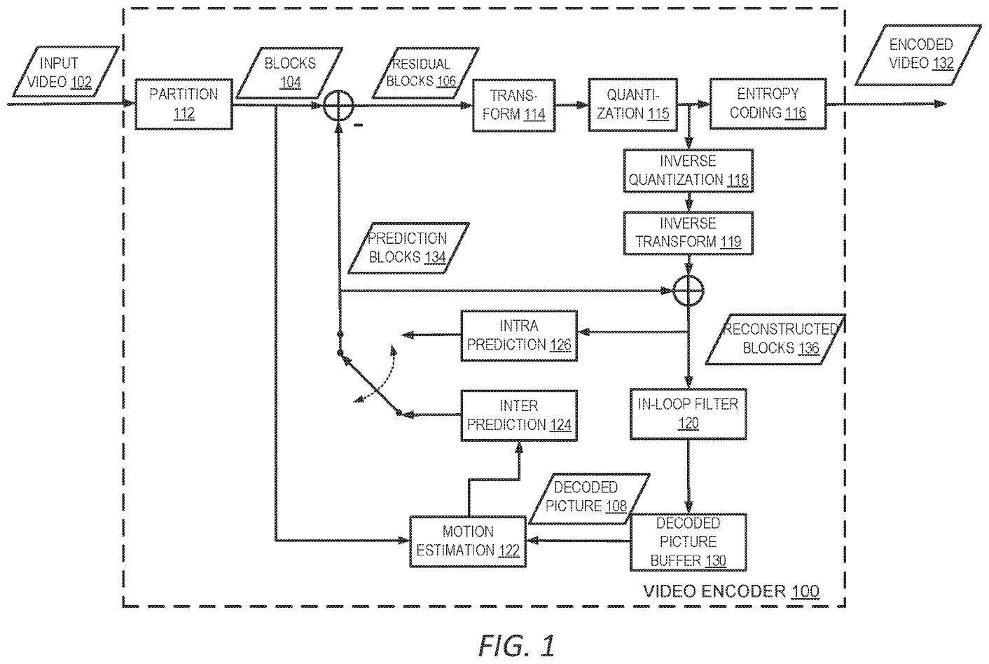

Referring now to the drawings, FIG. 1 is a block diagram showing an example of a video encoder 100 configured to implement embodiments presented herein. In the example shown in FIG. 1, the video encoder 100 includes a partition module 112, a transform module 114, a quantization module 115, an inverse quantization module 118, an inverse transform module 119, an in-loop filter module 120, an intra prediction module 126, an inter prediction module 124, a motion estimation module 122, a decoded picture buffer 130, and an entropy coding module 116.

The input to the video encoder 100 is an input video 102 containing a sequence of pictures (also referred to as frames or images). In a block-based video encoder, for each of the pictures, the video encoder 100 employs a partition module 112 to partition the picture into blocks 104, and each block contains multiple pixels. The blocks may be macroblocks, coding tree units, coding units, prediction units, and/or prediction blocks. One picture may include blocks of different sizes and the block partitions of different pictures of the video may also differ. Each block may be encoded using different predictions, such as intra prediction or inter prediction or intra and inter hybrid prediction.

Usually, the first picture of a video signal is an intra-coded picture, which is encoded using only intra prediction. In the intra prediction mode, a block of a picture is predicted using only data that has been encoded from the same picture. A picture that is intra-coded can be decoded without information from other pictures. To perform the intra-prediction, the video encoder 100 shown in FIG. 1 can employ the intra prediction module 126. The intra prediction module 126 is configured to use reconstructed samples in reconstructed blocks 136 of neighboring blocks of the same picture to generate an intra-prediction block (the prediction block 134). The intra prediction is performed according to an intra-prediction mode selected for the block. The video encoder 100 then calculates the difference between block 104 and the intra-prediction block 134. This difference is referred to as residual block 106.

To further remove the redundancy from the block, the residual block 106 is transformed by the transform module 114 into a transform domain by applying a transform on the samples in the block. Examples of the transform may include, but are not limited to, a discrete cosine transform (DCT) or discrete sine transform (DST). The transformed values may be referred to as transform coefficients representing the residual block in the transform domain. In some examples, the residual block may be quantized directly without being transformed by the transform module 114. This is referred to as a transform skip mode.

The video encoder 100 can further use the quantization module 115 to quantize the transform coefficients to obtain quantized coefficients. Quantization includes dividing a sample by a quantization step size followed by subsequent rounding, whereas inverse quantization involves multiplying the quantized value by the quantization step size. Such a quantization process is referred to as scalar quantization. Quantization is used to reduce the dynamic range of video samples (transformed or non-transformed) so that fewer bits are used to represent the video samples.

The quantization of coefficients/samples within a block can be done independently and this kind of quantization method is used in some existing video compression standards, such as H.264, HEVC, and VVC. For an N-by-M block, some scan order may be used to convert the 2D coefficients of a block into a 1-D array for coefficient quantization and coding. Quantization of a coefficient within a block may make use of the scan order information. For example, the quantization of a given coefficient in the block may depend on the status of the previous quantized value along the scan order. In order to further improve the coding efficiency, more than one quantizer may be used. Which quantizer is used for quantizing a current coefficient depends on the information preceding the current coefficient in the encoding/decoding scan order. Such a quantization approach is referred to as dependent quantization.

The degree of quantization may be adjusted using the quantization step sizes. For instance, for scalar quantization, different quantization step sizes may be applied to achieve finer or coarser quantization. Smaller quantization step sizes correspond to finer quantization, whereas larger quantization step sizes correspond to coarser quantization. The quantization step size can be indicated by a quantization parameter (QP). Quantization parameters are provided in an encoded bitstream of the video such that the video decoder can access and apply the quantization parameters for decoding.

The quantized samples are then coded by the entropy coding module 116 to further reduce the size of the video signal. The entropy encoding module 116 is configured to apply an entropy encoding algorithm to the quantized samples. In some examples, the quantized samples are binarized into binary bins and coding algorithms further compress the binary bins into bits. Examples of the binarization methods include, but are not limited to, a combined truncated Rice (TR) and limited k-th order Exp-Golomb (EGk) binarization, and k-th order Exp-Golomb binarization. Examples of the entropy encoding algorithm include, but are not limited to, a variable length coding (VLC) scheme, a context adaptive VLC scheme (CAVLC), an arithmetic coding scheme, a binarization, a context adaptive binary arithmetic coding (CABAC), syntax-based context-adaptive binary arithmetic coding (SBAC), probability interval partitioning entropy (PIPE) coding, or other entropy encoding techniques. The entropy-coded data is added to the bitstream of the output encoded video 132.

As discussed above, reconstructed blocks 136 from neighboring blocks are used in the intra-prediction of blocks of a picture. Generating the reconstructed block 136 of a block involves calculating the reconstructed residuals of this block. The reconstructed residual can be determined by applying inverse quantization and inverse transform to the quantized residual of the block. The inverse quantization module 118 is configured to apply the inverse quantization to the quantized samples to obtain de-quantized coefficients. The inverse quantization module 118 applies the inverse of the quantization scheme applied by the quantization module 115 by using the same quantization step size as the quantization module 115. The inverse transform module 119 is configured to apply the inverse transform of the transform applied by the transform module 114 to the de-quantized samples, such as inverse DCT or inverse DST. The output of the inverse transform module 119 is the reconstructed residuals for the block in the pixel domain. The reconstructed residuals can be added to the prediction block 134 of the block to obtain a reconstructed block 136 in the pixel domain. For blocks where the transform is skipped, the inverse transform module 119 is not applied to those blocks. The de-quantized samples are the reconstructed residuals for the blocks.

Blocks in subsequent pictures following the first intra-predicted picture can be coded using either inter prediction or intra prediction. In inter-prediction, the prediction of a block in a picture is from one or more previously encoded video pictures. To perform inter prediction, the video encoder 100 uses an inter prediction module 124. The inter prediction module 124 is configured to perform motion compensation for a block based on the motion estimation provided by the motion estimation module 122.

The motion estimation module 122 compares a current block 104 of the current picture with decoded reference pictures 108 for motion estimation. The decoded reference pictures 108 are stored in a decoded picture buffer 130. The motion estimation module 122 selects a reference block from the decoded reference pictures 108 that best matches the current block. The motion estimation module 122 further identifies an offset between the position (e.g., x, y coordinates) of the reference block and the position of the current block. This offset is referred to as the motion vector (MV) and is provided to the inter prediction module 124 along with the selected reference block. In some cases, multiple reference blocks are identified for the current block in multiple decoded reference pictures 108. Therefore, multiple motion vectors are generated and provided to the inter prediction module 124 along with the corresponding reference blocks.

The inter prediction module 124 uses the motion vector(s) along with other inter-prediction parameters to perform motion compensation to generate a prediction of the current block, i.e., the inter prediction block 134. For example, based on the motion vector(s), the inter prediction module 124 can locate the prediction block(s) pointed to by the motion vector(s) in the corresponding reference picture(s). If there is more than one prediction block, these prediction blocks are combined with some weights to generate a prediction block 134 for the current block.

For inter-predicted blocks, the video encoder 100 can subtract the inter-prediction block 134 from block 104 to generate the residual block 106. The residual block 106 can be transformed, quantized, and entropy coded in the same way as the residuals of an intra-predicted block discussed above. Likewise, the reconstructed block 136 of an inter-predicted block can be obtained through inverse quantizing, inverse transforming the residual, and subsequently combining with the corresponding prediction block 134.

To obtain the decoded picture 108 used for motion estimation, the reconstructed block 136 is processed by an in-loop filter module 120. The in-loop filter module 120 is configured to smooth out pixel transitions thereby improving the video quality. The in-loop filter module 120 may be configured to implement one or more in-loop filters, such as a de-blocking filter, a sample-adaptive offset (SAO) filter, an adaptive loop filter (ALF), etc.

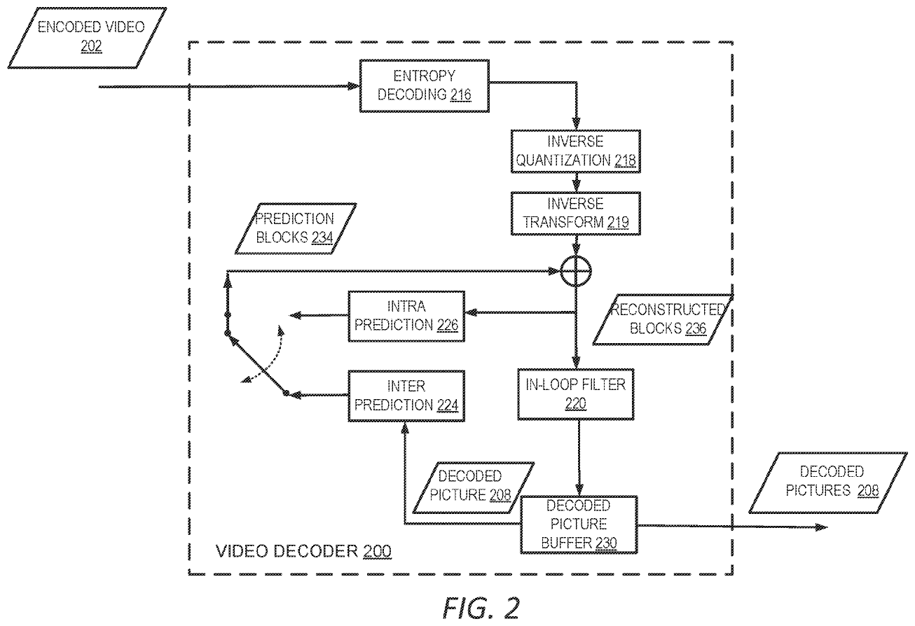

FIG. 2 depicts an example of a video decoder 200 configured to implement the embodiments presented herein. The video decoder 200 processes an encoded video 202 in a bitstream and generates decoded pictures 208. In the example shown in FIG. 2, the video decoder 200 includes an entropy decoding module 216, an inverse quantization module 218, an inverse transform module 219, an in-loop filter module 220, an intra prediction module 226, an inter prediction module 224, and a decoded picture buffer 230.

The entropy decoding module 216 is configured to perform entropy decoding of the encoded video 202. The entropy decoding module 216 decodes the quantized coefficients, coding parameters including intra prediction parameters and inter prediction parameters, and other information. In some examples, the entropy decoding module 216 decodes the bitstream of the encoded video 202 to binary representations and then converts the binary representations to quantization levels of the coefficients. The entropy-decoded coefficient levels are then inverse quantized by the inverse quantization module 218 and subsequently inverse transformed by the inverse transform module 219 to the pixel domain. The inverse quantization module 218 and the inverse transform module 219 function similarly to the inverse quantization module 118 and the inverse transform module 119, respectively, as described above with respect to FIG. 1. The inverse-transformed residual block can be added to the corresponding prediction block 234 to generate a reconstructed block 236. For blocks where the transform is skipped, the inverse transform module 219 is not applied to those blocks. The de-quantized samples generated by the inverse quantization module 118 are used to generate the reconstructed block 236.

The prediction block 234 of a particular block is generated based on the prediction mode of the block. If the coding parameters of the block indicate that the block is intra predicted, the reconstructed block 236 of a reference block in the same picture can be fed into the intra prediction module 226 to generate the prediction block 234 for the block. If the coding parameters of the block indicate that the block is inter-predicted, the prediction block 234 is generated by the inter prediction module 224. The intra prediction module 226 and the inter prediction module 224 function similarly to the intra prediction module 126 and the inter prediction module 124 of FIG. 1, respectively.

As discussed above with respect to FIG. 1, the inter prediction involves one or more reference pictures. The video decoder 200 generates the decoded pictures 208 for the reference pictures by applying the in-loop filter module 220 to the reconstructed blocks of the reference pictures. The decoded pictures 208 are stored in the decoded picture buffer 230 for use by the inter prediction module 224 and also for output.

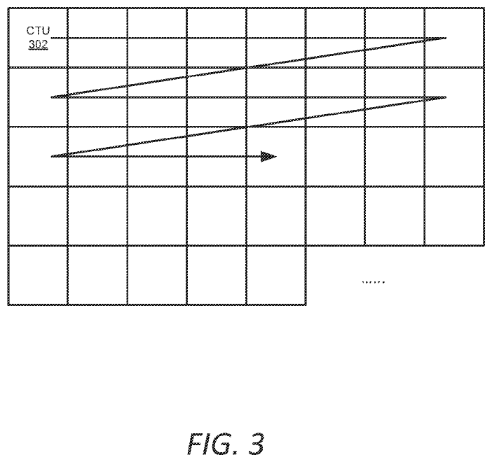

Referring now to FIG. 3, FIG. 3 depicts an example of a coding tree unit division of a picture in a video, according to some embodiments of the present disclosure. As discussed above with respect to FIGS. 1 and 2, to encode a picture of a video, the picture is divided into blocks, such as the CTUs (Coding Tree Units) 302 in VVC, as shown in FIG. 3. For example, the CTUs 302 can be blocks of 128×128 pixels. The CTUs are processed according to an order, such as the order shown in FIG. 3.

### Entropy Coding

In video coding standard such as VVC, context-based binary arithmetic coding (CABAC) is employed as entropy coding method. In binary arithmetic coding, the coding engine consists of two elements: probability estimation and codeword mapping. The purpose of probability estimation is to determine the likelihood of the next binary symbol having the value 1. This estimation is based on the history of symbol values coded using the same context and typically uses an exponential decay window. Given a sequence of binary symbols x(t), with t∈{1, . . . , N}, the estimated probability p(t+1) of x(t+1) being equal to 1 is given by

$$p ( t + 1 ) = p ( 1 ) + {\sum }_{k = 1}^{t} α * {( 1 - α )}^{t - k} * ( x ( t ) - p ( 1 ) ) \qquad ( 1 )$$

where p(1) is an initial probability estimate and a is a base determining the rate of adaptation. Alternatively, this can be expressed in a recursive manner as

$$p ( t + 1 ) = p ( t ) * ( 1 - α ) + x ( t ) * α \qquad ( 2 )$$

For each slice, the initial estimate p(1) is derived for each context using a linear function of the quantization parameter (QP).

Note that some blocks in a slice may be coded in a skip-mode without using CABAC, for example, to reduce the number of bits used for the slice. The blocks coded using the skip-mode do not contribute to the building of the context.

For each context variable, two variables pStateIdx0 and pStateIdx1 are initialized as follows. From a 6 bit table entry initValue, two 3 bit variables slopeIdx and offsetIdx are derived as:

$$slopeIdx = initValue ≫ 3 \qquad ( 3 )$$

$$offsetIdx = initValue \& 7$$

Variables m and n, used in the initialization of context variables, are derived from slopeIdx and offsetIdx as:

$$m = slopeIdx - 4 \qquad ( 4 )$$

$$n = ( offsetIdx * 18 ) + 1$$

The two values assigned to pStateIdx0 and pStateIdx1 for the initialization are derived from SliceQpy as specified in the VVC standard. Given the variables m and n, the initialization is specified as follows:

$$preCtxState = Clip 3 ( 1 , 127 , ( ( m * ( Clip 3 ( 0 , 63 , {SliceQp}_{Y} ) - 16 ) ) ≫ 1 ) + n ) \qquad ( 5 )$$

The two values assigned to pStateIdx0 and pStateIdx1 for the initialization are derived as follows:

$$pStateIdx 0 = preCtxState ≪ 3 \qquad ( 6 )$$

$$pStateIdx 1 = preCtxState ≪ 7$$

initValue can be obtained with pre-defined Tables. initType, which is determined by the slice and the syntax element sh_cabac_init_flag, as extracted as follows, is the entry of the Tables.

| | |
|---|---|
| if( sh_slice_type = = I ) | |
| initType = 0 | |
| else if( sh_slice_type = = P ) | |
| initType = sh_cabac_init_flag ? 2 : 1 | (7) |
| else | |
| initType = sh_cabac_init_flag ? 1 : 2 | |

Syntax elements related to sh_cabac_init_flag are shown in Table 1, Table 2 and Table 4, respectively. In PPS, syntax element pps_cabac_init_present_flag is transmitted as shown in Table 1.
pps_cabac_init_present_flag equal to 1 specifies that sh_cabac_init_flag is present in slice headers referring to the PPS. pps_cabac_init_present_flag equal to 0 specifies that sh_cabac_init_flag is not present in slice headers referring to the PPS.

TABLE 1
pps_cabac_init_present_flag in PPS (VVC specification):

| | Descriptor |
|---|---|
| pic_parameter_set_rbsp( ) { | |
| ... | |
| pps_cabac_init_present_flag | u(1) |
| ... | |
| } | |

In picture_header_structure( ), syntax element ph_inter_slice_allowed_flag is transmitted as shown in Table 2.
ph_inter_slice_allowed_flag equal to 0 specifies that all coded slices of the picture have sh_slice_type equal to 2. ph_inter_slice_allowed_flag equal to 1 specifies that there might or might not be one or more coded slices in the picture that have sh_slice_type equal to 0 or 1.

TABLE 2
ph_inter_slice_allowed_flag in
picture_header_structure( ) (VVC specification)

| | Descriptor |
|---|---|
| picture_header_structure( ) { | |
| ... | |
| ph_inter_slice_allowed_flag | u(1) |
| ... | |
| } | |

In slice_header( ) syntax elements sh_slice_type and sh_cabac_init_flag are transmitted as shown in Table 4.
sh_slice_type specifies the coding type of the slice according to table 3.

TABLE 3
sh_slice_type in slice_heaeder( ) (VVC Specification)

| sh_slice_type | Name of sh_slice_type |
|---|---|
| 0 | B (B slice) |
| 1 | P (P slice) |
| 2 | I (I slice) |

sh_cabac_init_flag specifies the method for determining the initialization table used in the initialization process for context variables. When sh_cabac_init_flag is not present, it is inferred to be equal to 0.

TABLE 4
sh_slice_type and sh_cabac_init_flag
in slice_header( ) (VVC specification)

| | Descriptor |
|---|---|
| slice_header( ) { | |
| ... | |
| if( ph_inter_slice_allowed_flag ) | |
| sh_slice_type | ue(v) |
| ... | |
| if( sh_slice_type != I ) { | |
| if( pps_cabac_init_present_flag ) | |
| sh_cabac_init_flag | u(1) |
| ... | |
| } | |

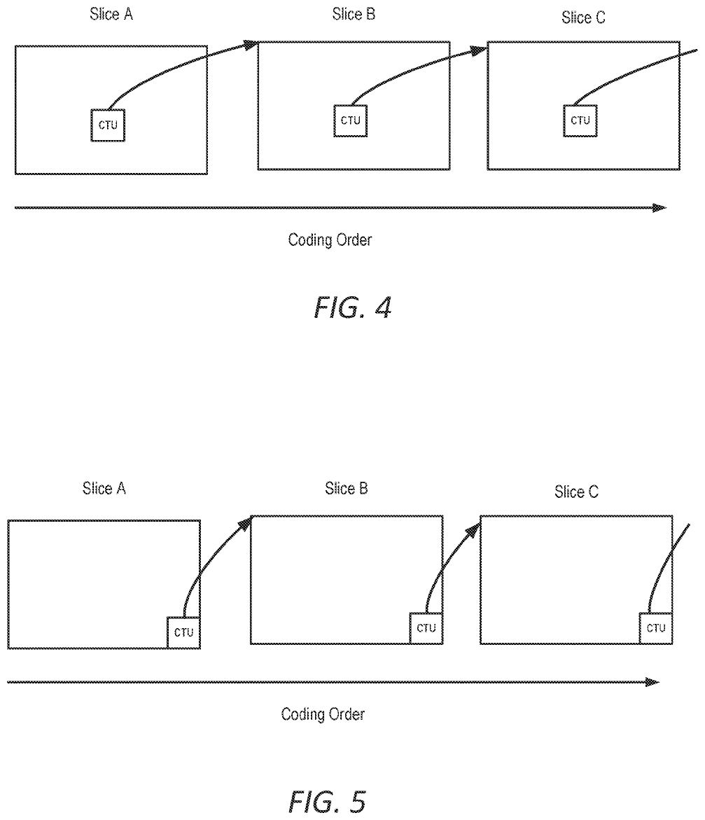

In some examples, previously coded slices or frames can be utilized for CABAC initialization. FIG. 4 depicts an example of the CABAC context initialization from the previous frame (CIPF). As shown in FIG. 4, if the current slice type is a B or P, the probability state (i.e., the context value) of each context model is first obtained after coding CTUs up to a specified location and stored. Then, the stored probability state will be used as the initial probability state for the corresponding context model in the next B- or P-slice coded with the same quantization parameter (QP) and the same temporal ID (Tid). The CTU location for storing probability states is computed using the following formula:

$$CTU location = min ( ( W + C ) / 2 + 1 , C ) \qquad ( 8 )$$

where W denotes the number of CTUs in a CTU row, and C is the total number of CTUs in a slice.

A syntax element sps_cipf_enabled_flag in the sequence parameter set (SPS) can be used as shown in Table 5 to indicate whether the context initialization from previous frame is enabled or not. If the value of sps_cipf_enabled_flag is equal to 1, the context initialization from previous frame described above is used for each slice associated with the SPS. If the value of sps_cipf_enabled_flag is equal to 0, the CABAC context initialization process same as that specified in VVC is applied for each slice associated with the SPS.

TABLE 5
sps_cipf_enabled_flag syntax in SPS

| | Descriptor |
|---|---|
| seq_parameter_set_rbsp( ) { | |
| ... | |
| sps_cipf_enabled_flag | u(1) |
| ... | |
| } | |

In the VVC specification, the quantization parameter QP for a slice is derived as follows. The syntax elements pps_no_pic_partition_flag, pps_init_qp_minus26 and pps_qp_delta_info_in_ph_flag are transmitted in the picture parameter set (PPS) as shown in Table 6.

TABLE 6
pps_no_pic_partition_flag, pps_{—}
init_qp_minus26 and ppc_qp_delta_info_in_{—}
ph_flag syntax in PPS (VVC Specification)

| | Descriptor |
|---|---|
| pic_parameter_set_rbsp( ) { | |
| ... | |
| pps_no_pic_partition_flag | u(1) |
| ... | |
| pps_init_qp_minus26 | se(v) |
| ... | |
| if( !pps_no_pic_partition_flag ) { | |
| ... | |
| pps_qp_delta_info_in_ph_flag | u(1) |
| ... | |
| } | u(1) |
| } | |

The syntax element ph_qp_delta is transmitted in picture_header_structure, as shown in Table 7.
ph_qp_delta specifies the initial value of QpY to be used for the coding blocks in the picture until modified by the value of CuQpDeltaVal in the coding unit layer. When pps_qp_delta_info_in_ph_flag is equal to 1, the initial value of the QpY quantization parameter for all slices of the picture, SliceQpY, is derived as follows:

$$SliceQpY = 26 + pps\_init \_qp \_minus26 + ph\_qp \_delta \qquad ( 9 )$$

TABLE 7
ph_qp_delta syntax in picture_{—}
header_structure( ) (VVC specification)

| | Descriptor |
|---|---|
| picture_header_structure( ) { | |
| ... | |
| if( pps_qp_delta_info_in_ph_flag ) | |
| ph_qp_delta | se(v) |
| ... | |
| } | |

The syntax sh_qp_delta is transmitted in slice_header_structure, as shown in Table 8. sh_qp_delta specifies the initial value of QpY to be used for the coding blocks in the slice until modified by the value of CuQpDeltaVal in the coding unit layer. When pps_qp_delta_info_in_ph_flag is equal to 0, the initial value of the QpY quantization parameter for the slice, SliceQpY, is derived as follows:

$$SliceQpY = 26 + pps\_init \_qp \_minus26 + sh\_qp \_delta \qquad ( 10 )$$

TABLE 8
sh_qp_delta syntax in slice_{—}
header_structure( ) (VVC specification)

| | Descriptor |
|---|---|
| slice_header( ) { | |
| ... | |
| if( !pps_qp_delta_info_in_ph_flag ) | |
| sh_qp_delta | se(v) |
| ... | |
| } | |

In the VVC specification, the number of temporal layers (sublayers) are defined in video parameter set (VPS) and in sequence parameter set (SPS), as shown in Table 9 and in Table 10.

vps_max_sublayers_minus1 plus 1 specifies the maximum number of temporal sublayers that may be present in a layer specified by the VPS. The value of vps_max_sublayers_minus1 shall be in the range of 0 to 6, inclusive.

TABLE 9
Definition of The Number of Temporal
Layers in VPS (VVC Specification)

| | Descriptor |
|---|---|
| video_parameter_set_rbsp( ) { | |
| ... | |
| vps_max_sublayers_minus1 | u(3) |
| ... | |
| } | |

sps_max_sublayers_minus1 plus 1 specifies the maximum number of temporal sublayers that could be present in each CLVS (coded layer video sequence) referring to the SPS. If sps_video_parameter_set_id is greater than 0, the value of sps_max_sublayers_minus1 shall be in the range of 0 to vps_max_sublayers_minus1, inclusive.
Otherwise (sps_video_parameter_set_id is equal to 0), the following applies:
The value of sps_max_sublayers_minus1 shall be in the range of 0 to 6, inclusive.
The value of vps_max_sublayers_minus1 is inferred to be equal to sps_max_sublayers_minus1.
The value of NumSubLayersInLayerInOLS[0][0] is inferred to be equal to sps_max_sublayers_minus1+1.
The value of vps_ols_ptl_idx[0] is inferred to be equal to 0, and the value of vps_ptl_max_tid[vps_ols_ptl_idx[0]], i.e., vps_ptl_max_tid[0], is inferred to be equal to sps_max_sublayers_minus1.

TABLE 10
Definition of The Number of Temporal
Layers in VPS (VVC Specification)

| | Descriptor |
|---|---|
| seq_parameter_set_rbsp( ) { | |
| ... | |
| sps_max_sublayers_minus1 | u(3) |
| ... | |
| } | |

Generally, transform coefficients consume most of the bits within video bitstreams. If a number of bits are spent for the slice, the context table or context value is more tailored as encoding proceeds from one CTU to another. On the other hand, the texture may differ from the first CTU to the last CTU. In this case, a good trade-off can be achieved by using the context value of a CTU in the centre of the slice to initialize the context for the next slice as shown in FIG. 4. However, if fewer bits are spent for the slice, more blocks are coded as skip mode. In this case, the context table cannot be tailored for the texture because there are not enough context-coded blocks in the slice. In this case, the context value of a CTU near the end of the slice along the encoding order (e.g., the order shown in FIG. 3) can be used to initialize the context for the next slice. For example, the last CTU of the slice can be used to initialize the context for the next slice as shown in FIG. 5. That is, instead of the Eqn. (8), the CTU location for storing probability states is computed using the following formula:

$$CTU location = C , \qquad ( 11 )$$

where C is the total number of CTUs in a slice.

The CTU location used for initializing the context for the next slice can be adaptively switched between the Eqns. (8) and (11). In one embodiment, if the value of sps_cipf_flag=1, additional syntax sps_cipf_center_flag can be transmitted, as shown in Table 11 below.

TABLE 11
Proposed Syntax of sps_cipf_center_flag

| | Descriptor |
|---|---|
| seq_parameter_set_rbsp( ) { | |
| ... | |
| sps_cipf_enabled_flag | u(1) |
| if( sps_cipf_enabled_flag ) | |
| sps_cipf_center_flag | u(1) |
| ... | |
| } | |

sps_cipf_enabled_flag equal to 1 specifies that for each slice the CTU location for storing probability states is specified by sps_cipf_center_flag. sps_cipf_enabled_flag equal to 0 specifies that the probability states for each slice are reset to the default initial values.
sps_cipf_center_flag specifies the CTU location for storing probability states. sps_cipf_center_flag equal to 1 specified that for each slice the CTU location for storing probability states is computed using the following formula:

$$CTU location = min ( ( W + C ) / 2 + 1 , C )$$

sps_cipf_center_flag equal to 0 specified that for each slice the CTU location for storing probability states is computed using the following formula:

CTU location=C

where W denote the number of CTUs in a CTU row, and C is the total number of CTUs in a slice. If sps_cipf_center_flag is not present, the value of sps_cipf_center_flag is inferred to be equal to 0.

If the bitrate of the bitstream is higher, or the QP for each slice is lower, more blocks are coded with the context-based mode (i.e., non-skip mode) and sps_cipf_center_flag=1 provides better coding efficiency. On the contrary, if the bitrate of the bitstream is lower, or the QP for each slice is higher, fewer blocks are coded with context-based mode or non-skip mode and sps_cipf_center_flag=0 provides better coding efficiency. As such, in a second embodiment, a pre-determined threshold can be transmitted in the SPS and used to be compared with the slice QP value to determine whether to use the center CTU or the last CTU of the slice for context initialization for the next slice.

For example, a pre-determined threshold cipf_QP_threshold can be transmitted in the SPS as shown in Table 12, and the QP of the previous slice, sliceQP, can be compared with the value of cipf_QP_threshold to determine the location CTU_location of the CTU that is used to initialize the context of the slice as follows:

```
if sliceQP <= cipf_QP_threshold
  CTU location = min ((W + C)/2 + 1, C)
else
  CTU location = C
```

TABLE 12
Proposed Syntax of cipf_QP_threshold

| | Descriptor |
|---|---|
| seq_parameter_set_rbsp( ) { | |
| ... | |
| sps_cipf_enabled_flag | u(1) |
| if( sps_cipf_enabled_flag ) | |
| sps_cipf_QP_threshold | ue(v) |
| ... | |
| } | |

sps_cipf_enabled_flag equal to 1 specifies that for each slice the CTU location for storing probability states is specified by sps_cipf_QP_threshold. sps_cipf_enabled_flag equal to 0 specifies that the probability states for each slice are reset to the default initial values.
sps_cipf_QP_threshold specifies the QP threshold used to control how to decide the CTU location for entropy initialization if sps_cipf_enabled_flag is equal to 1. If the slice QP specified in the slice header is not bigger than this threshold,

$$CTU location = min ( ( W + C ) / 2 + 1 , C )$$

### Otherwise,

CTU location=C

where W denotes the number of CTUs in a CTU row, and C is the total number of CTUs in a slice.

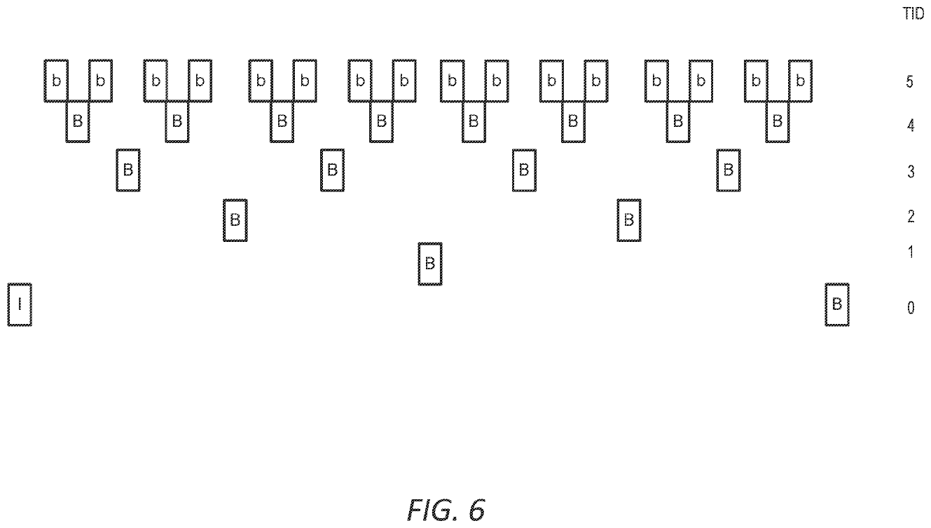

In another embodiment, the context initialization for the Random Access (RA) is considered. As part of the RA CTC, the Group of Pictures (GOP) structure for RA as shown in FIG. 6 is defined. In this GOP structure, pictures are divided into different temporal layers, such as the layer 0 to layer 5 in FIG. 6. In this example, an I-frame and a B-frame is in the temporal layer 0; temporal layer 1 has one B-frame; temporal layer 2 has two B-frames; and so on. A lower QP is applied to the pictures of lower temporal layer, and a higher QP is applied to the pictures of higher temporal layer. Coding efficiency improvement can be realized if more bits are spent for pictures of lower temporal layer. As such, in pictures of higher temporal layers, more blocks are coded in the skip-mode and in this case, image quality of the reference frames is more important for coding efficiency.

In this case, a pre-determined sps_cipf_temporal_layer_threshold can be used to realize coding efficiency improvement. For example, the syntax elements cipf_enabled_temporal_layer_threshold and cipf_center_temporal_layer_threshold can be transmitted in SPS as shown in Table 13 with cipf_center_temporal_layer_threshold being no larger than cipf_enabled_temporal_layer_threshold.

TABLE 13
Proposed Syntax of cipf_temporal_layer_threshold

| | Descriptor |
|---|---|
| seq_parameter_set_rbsp( ) { | |
| ... | |
| sps_max_sublayers_minus1 | u(3) |
| ... | |
| sps_cipf_enabled_flag | u(1) |
| if( sps_cipf_enabled_flag ){ | |
| sps_cipf_enabled_temporal_layer_threshold | u(3) |
| sps_cipf_center_temporal_layer_threshold | u(3) |
| } | |
| ... | |
| } | |

sps_cipf_enabled_flag equal to 1 specifies CABAC context initialization process for each slice associated to the SPS is specified with the following syntax elements sps_cipf_enabled_temporal_layer_threshold and sps_cipf_center_temporal_layer_threshold. sps_cipf_enabled_flag equal to 0 specifies that CABAC context initialization process for all the slices is the same and reset to the default initial values.
sps_cipf_enabled_temporal_layer_threshold specifies the maximum Tid value where CABAC context initialization from the previous frame is applied. If the value of Tid for the current slice is larger than sps_cipf_enabled_tempral_layer_threshold, CABAC context initialization process specified by VVC is applied. The value of sps_cipf_enabled_temporal_layer_threhsold shall e in the range of 0 to sps_max_sublayers_minus1+1, inclusive.
sps_cipf_center_temporal_layer_threshold specifies the maximum Tid value where CABAC context initialization specified by FIG. 4 is applied. If the value of Tid for the current slice is larger than sps_cipf_center_temporal_layer_threshold, CABAC context initialization specified by FIG. 4 is applied, that is,

```
if Tid <= sps_cipf_center_temporal_layer_threshold
  CTU location = min ((W + C)/2 + 1, C)
else
  CTU location = C
```

where Tid denotes temporal layer index, W denote the number of CTUs in a CTU row, and C is the total number of CTUs in a slice.
The value of sps_cipf_center_temporal_layer_threhsold shall be in the range of 0 to sps_cipf_enabled_temporal_layerthreshold, inclusive.

One more benefit of using the syntax element sps_cipf_enabled_temporal_layer_threshold is that the context values need to be stored can be reduced. For example, in FIG. 6, if the value of sps_cipf_enabled_temporal_layer_threshold is 5, CABAC context initialization values need to be stored for Tid 2, 3, 4 and 5. However if the value of sps_cipf_enabled_temporal_layer_threshold is 3, CABAC context initialization tables need to be stored only for Tid 2 and 3. This is useful if the storage of the encoder or the decoder is limited.

In another embodiment, cipf_enabled_flag is transmitted in the picture_header or in the slice_header. If cipf_enabled_flag is transmitted in the picture_header or in the slice_header, cipf_center_flag is also transmitted in the picture_header or in the slice_header. The proposed syntax of SPS, PPS, picture_header and slice header are shown in Tables 14, 15, 16, and 17 respectively.

TABLE 14
Proposed Syntax of sps_cipf_enabled_flag in SPS

| | Descriptor |
|---|---|
| seq_parameter_set_rbsp( ) { | |
| ... | |
| sps_cipf_enabled_flag | u(1) |
| ... | |
| } | |

TABLE 15
Proposed Syntax of pps_cipf_in_ph_flag

| | Descriptor |
|---|---|
| pic_parameter_set_rbsp( ) { | |
| ... | |
| pps_no_pic_partition_flag | u(1) |
| ... | |
| if( !pps_no_pic_partition_flag ) { | |
| ... | |
| pps_cipf_info_in_ph_flag | u(1) |
| ... | |
| } | u(1) |
| } | |

TABLE 16
Proposed Syntax of ph_cipf_enabled_flag and ph_cipf_center_flag

| | Descriptor |
|---|---|
| picture_header_structure( ) { | |
| ... | |
| ph_inter_slice_allowed_flag | u(1) |
| ... | |
| if( sps_cipf_enabled_flag && pps_cipf_info_in_ph_flag && | |
| ph_inter_slice_allowed_flag ){ | |
| ph_cipf_enabled_flag | u(1) |
| if( ph_cipf_enabled_flag ) | |
| ph_cipf_center_flag | u(1) |
| } | |
| ... | |
| } | |

TABLE 17
Proposed Syntax of sh_cipf_enabled_flag and sh_cipf_center_flag

| | Descriptor |
|---|---|
| slice_header( ) { | |
| ... | |
| if( ph_inter_slice_allowed_flag ) | |
| sh_slice_type | ue(v) |
| ... | |
| if( sps_cipf_enabled_flag && !pps_cipf_info_in_ph_flag && slice_type != | |
| I ){ | |
| sh_cipf_enabled_flag | u(1) |
| if( sh_cipf_enabled_flag ) | |
| sh_cipf_center_flag | u(1) |
| } | |
| ... | |
| } | |

sps_cipf_enabled_flag equal to 1 specifies that the CABAC context initialization process for each slice associated with SPS is specified by the syntax elements ph_cipf_enabled_flag and ph_cipf_center_flag in picture_header_structure( ) or sh_cipf_enabled_flag and sh_cipf_center_flag in slice_header( ). sps_cipf_enabled_flag equal to 0 specifies that the CABAC context initialization process for each slice associated with SPS is same and reset to the default initial values.
pps_cipf_info_in_ph_flag equal to 1 specifies that ph_cipf_enabled_flag and ph_cipf_center_flag are transmitted in the picture_header_structure( ) syntax. pps_cipf_info_in_ph_flag equal to 0 specifies that ph_cipf_enabled_flag and ph_cipf_center_flag are not transmitted in the picture_header_structure( ) syntax, and sh_cipf_enabled_flag and sh_cipf_center_flag are transmitted in the slice_header( ) syntax.
ph_cipf_enabled_flag equal to 1 specifies that CABAC context initialization from the previous frame is applied to all the slices in the associated picture. ph_cipf_enabled_flag equal to 0 specifies that CABAC context initialization from the previous frame is applied to none of the slices in the associated picture and CABAC context initialization specified by VVC is applied for all the slices in the associated picture.
ph_cipf_center_flag equal to 1 specifies that, for all the slices in the associated picture, the CTU location for CABAC context initialization from the previous frame is obtained as

$$CTU location = min ( ( W + C ) / 2 + 1 , C )$$

ph_cipf_enabled_flag equal to 0 specifies that, for all the slices in the associated picture, the CTU location for CABAC context initialization from previous frame is obtained as

CTU location=C

where W denote the number of CTUs in a CTU row, and C is the total number of CTUs in a slice.
sh_cipf_enabled_flag equal to 1 specifies that CABAC context initialization from the previous frame is applied to the associated slice. sh_cipf_enabled_flag equal to 0 specifies that CABAC context initialization from the previous frame is not applied to the associated slice and CABAC context initialization is reset to the default initial.
sh_cipf_center_flag equal to 1 specifies that, for the associated slice, the CTU location for CABAC context initialization from the previous frame is obtained as

$$CTU location = min ( ( W + C ) / 2 + 1 , C )$$

sh_cipf_enabled_flag equal to 0 specifies that, for the associated slice, the CTU location for CABAC context initialization from previous frame is obtained as

CTU location=C

where W denote the number of CTUs in a CTU row, and C is the total number of CTUs in a slice.

As discussed above, by adaptive switching of the CTU location between the center and bottom-right for CABAC context initialization from the previous slice, the context initialization is more accurate for a slice and the entropy coded bits can be reduced, thereby improving the coding efficiency.

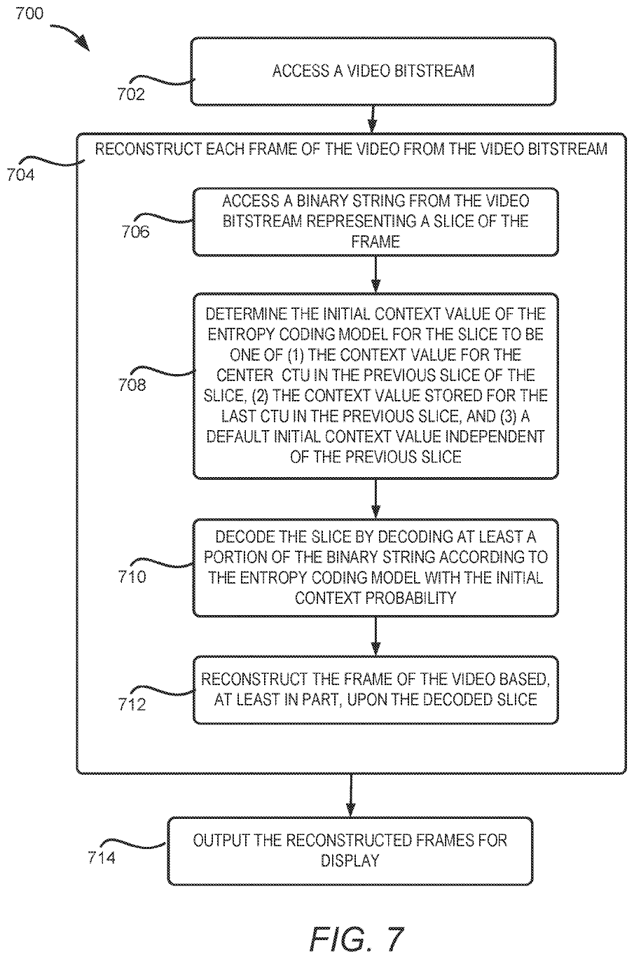

FIG. 7 depicts an example of a process 700 for decoding a video encoded via entropy coding with adaptive context initialization, according to some embodiments of the present disclosure. One or more computing devices (e.g., the computing device implementing the video decoder 200) implement operations depicted in FIG. 7 by executing suitable program code (e.g., the program code implementing the entropy decoding module 216). For illustrative purposes, the process 700 is described with reference to some examples depicted in the figures. Other implementations, however, are possible.

At block 702, the process 700 involves accessing a video bitstream representing a video signal. The video bitstream is encoded by a video encoder using an entropy coding with the adaptive context initialization presented herein. At block 704, which includes blocks 706-712, the process 700 involves reconstructing each frame of the video from the video bitstream. At block 706, the process 700 involves accessing a binary bit string from the video bitstream that represents a slice of the frame. At block 708, the process 700 involves determining the initial context value (e.g., p(1) in Eqn. (1)) of an entropy coding model for the slice. The determination can be made adaptively for the slice to be one of three options: the context value stored for a CTU located near the center of the previous slice (e.g., the CTU indicated by Eqn. (8)), the context value stored for the CTU near the end of the previous slice (e.g., the last CTU indicated by Eqn. (11)), and the default initial context value specified in the VVC specification as shown in Eqn. (5). In one example, the order of the CTUs of the previous slice is determined by the scanning order as explained above with respect to FIG. 3.

In one embodiment, a syntax element can be used to indicate the CTU location for obtaining the initial context value from the previous slice, such as the syntax element sps_cipf_center_flag described above. If the syntax element sps_cipf_center_flag has value 1, the initial context value can be set to the context value stored for the center CTU of the previous slice; if the syntax element sps_cipf_center_flag has a value 0, the initial context value can be set to the context value stored for the last CTU of the previous slice. Another syntax element, such as sps_cipf_enabled_flag, can be used to indicate whether to use the context value from the previous slice for initialization or use the default initial context value. In some examples, both syntax elements sps_cipf_center_flag and sps_cipf_enabled_flag can be transmitted in the picture header (PH) of the frame containing the slice or the slice header (SH) of the slice. As such, determining the initial context value can be performed by extracting the syntax elements sps_cipf_center_flag and sps_cipf_enabled_flag from the bitstream and selecting the proper initial context value based on the value of the syntax elements.

In a further embodiment, a syntax element (e.g., sps_cipf_QP_threshold described above) indicating the threshold value for determining a CTU location for obtaining the initial context value from the previous slice can be used. The quantization parameter (QP) value of the previous slice can be compared with the threshold value sps_cipf_QP_threshold. If the QP value is smaller than or equal to the threshold value, the initial context value can be set to be the context value of the center CTU of the previous slice; otherwise, the initial context value can be set to be the context value of the last CTU of the previous slice.

In another embodiment, the initialization can be made based on the temporal layer indices associated with the frames in a group of pictures (GOP) structure for random access (RA). For example, two syntax elements can be used: a syntax element, such as sps_cipf_enabled_temporal_layer_threshold discussed above, indicating a threshold value for determining whether to use the initial context value from the previous slice and a syntax element, such as sps_cipf_center_temporal_layer_threshold discussed above, indicating a second threshold value for determining a CTU location for obtaining the initial context value from the previous slice. The sps_cipf_center_temporal_layer_threshold is set to be no higher than sps_cipf_enabled_temporal_layer_threshold. If the temporal layer index Tid of the current slice is higher than sps_cipf_enabled_temporal_layer_threshold, the initial context value for the slice is set to be the default initial context value. If the temporal layer index Tid is no higher than the sps_cipf_enabled_temporal_layer_threshold, the temporal layer index Tid of the slice is compared with the sps_cipf_center_temporal_layer_threshold. If the temporal layer index Tid is no higher than sps_cipf_center_temporal_layer_threshold, the initial context value is determined to be the context value of the center CTU of the previous slice; otherwise, the initial context value is set to be the context value of the last CTU of the previous slice.

At block 710, the process 700 involves decoding the slice by decoding the entropy coded portion of the binary string using the entropy coding model with the determined initial context value. The entropy decoded values may represent quantized and transformed residuals of the slice. At block 712, the process 700 involves reconstructing the frame based on the decoded slice. The reconstruction can include dequantization and inverse transformation of the entropy decoded values as described above with respect to FIG. 2 to reconstruct the pixel samples of the slice. The operations in blocks 706-712 can be performed for other slices of the frame to reconstruct the frame. At block 714, the reconstructed frames may be output for displaying.

It should be understood that the examples described above are for illustration purposes and should not be construed as limiting. Different implementations may be employed for adaptive context initialization. For example, instead of using the center CTU indicated in Eqn. (8), any CTU located in the center CTU rows (e.g., the center 1-5 CTU rows) of the slice can be used as the first of the three options. Similarly, instead of using the last CTU as indicated in Eqn. (11), any CTU in the last several CTU rows (e.g., last 1-3 CTU rows) can be used as the second option, as along as the CTU location in the first option is before the CTU location in the second option. In addition, while some of the examples focus on applying the CIPF to a slice, the same method can be applied to the frame using the stored context value for a CTU (e.g., the center CTU or an end CTU) in the previous frame or the last slice in the previous frame.

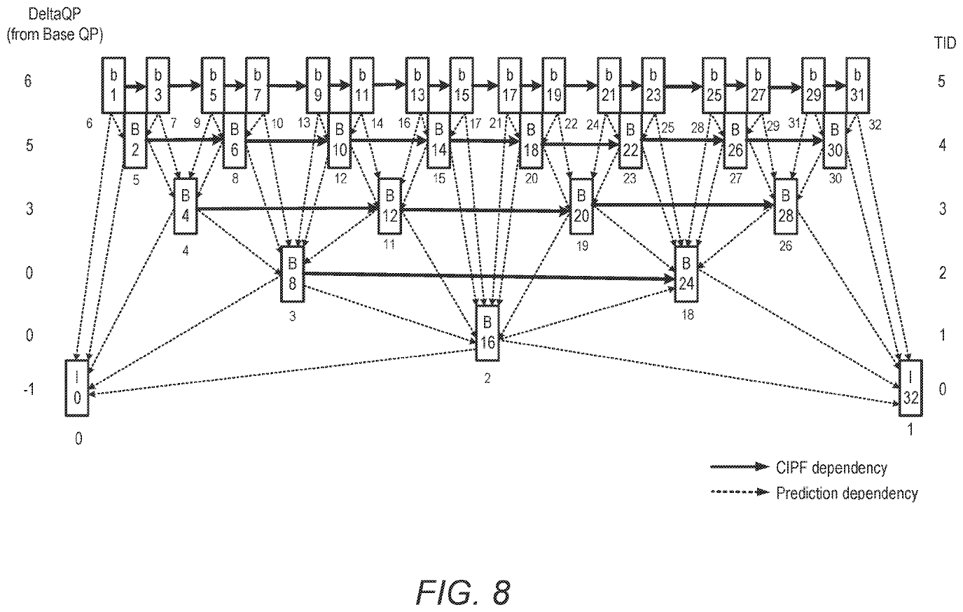

FIG. 8 shows an example of the motion compensation and entropy coding context initialization dependencies of a picture coding structure for random access (RA) common test condition (CTC) applied with the CIPF. In FIG. 8, each box represents a frame. The letter inside the box indicates the picture type of the frame and the number indicates the picture order count (POC) of the frame in the display order. The number below the box indicates the position of the frame in the coding order. The right side of the drawing shows the temporal layer index Tid of each temporal layer similar to those shown in FIG. 6. The left side of the drawing shows the delta QP for each temporal layer which is the difference between the QP of the layer and a base QP. The dotted lines between boxes indicate the prediction dependency and the solid lines indicate the CIPF dependentcy. As can be seen from FIG. 8, context initialization inheritance introduces additional dependencies between pictures, which would limit parallel processing capability for both the encoding and decoding. Some embodiments are presented herein to solve this problem.

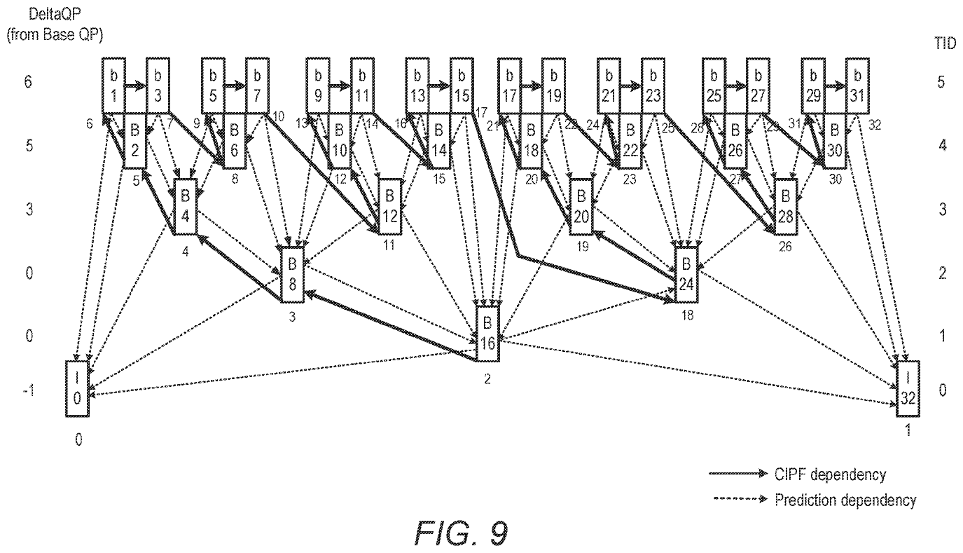

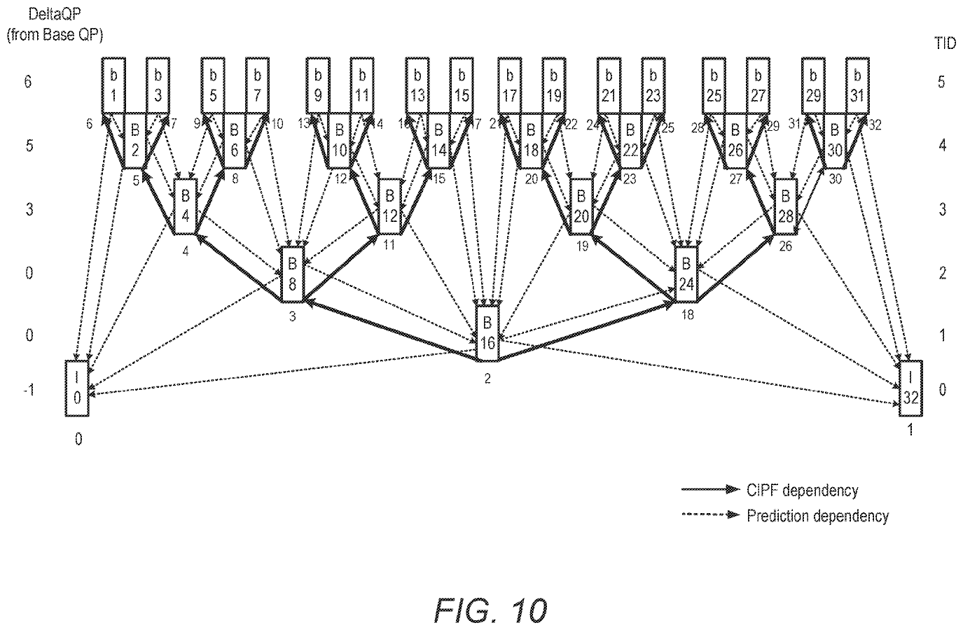

In one example, the context initialization value inherits from the previous picture in the coding order regardless of temporal layer and QP as shown in the example of FIG. 9. In another example, the context initialization value inherits from the previous picture of lower temporal layer as shown in the example of FIG. 10. In a further example, the context initialization table inheritance follows the motion compensation and prediction structure and uses the reference frame for motion compensation as the “previous” frame to inherit the state of the context variables for initilizing the context variables for the current frame. The context intialization value inheritance of this example can be demonstrated by the motion compensation and prediction paths shown as “prediction dependency” in dotted lines FIG. 9 and FIG. 10. In addition, the context value may inherit from multiple frames when multiple reference frames are involved in motion prediction and compensation. In this case, the context value initialization may be a combination of these inherited values such as an average or a weighted average. In some examples, coding standards like VVC, ECM, AVC and HEVC supports multiple reference frames and reference index can differ from block to block even within a single slice. In addition, coding standards like VVC, ECM, AVC and HEVC supports bi-prediction: list 0 prediction and list 1 prediction typically forward prediction and backward prediction. In such scenarios, the reference frame of index equal to 0 in the list 0 prediction can be used for CABAC inheritance. In the following, “slice” may be used to refer to a slice or a frame where the slice is the entire frame. The “previous” slice from which the context intialization table is inherited for the current slice may also be referred to as a “reference slice.”

For each of the examples above, the context initialization value is inherited from the frame with a different QP value. Directly inheriting context initialization table of the different QP value can cause loss in coding efficiency. To avoid the loss, context initialization table convertion based on the previous QP and the current QP can be implemented.

In one embodiment, assuming that the QP of the reference slice and the current slice are QpY_prev and QpY_curr, respectively, and the m and n specified in Eqn. (4) of the reference and the current slice is m_prev and n_prev and, m_curr and n_curr respectively. Eqn. (5) can be re-written as

$$preCtxState ( Qp\_prev ) = Clip 3 ( 1 , 127 , ( ( m\_prev * ( Clip 3 ( 0 , 63 , {Qp}_{Y \_ prev} ) - 16 ) ) ≫ 1 ) + n\_prev ) \qquad ( 12 )$$

$$preCtxState ( Qp\_curr ) = Clip 3 ( 1 , 127 , ( ( m\_curr * ( Clip 3 ( 0 , 63 , {Qp}_{Y \_ curr} ) - 16 ) ) ≫ 1 ) + n\_curr ) \qquad ( 13 )$$

Here, m and n are not dependent on the slice QP value. But because the values of sh_cabac_init_flag may be different for the previous and the current slices, m and n may be different for the previous slice and the current slice.

In this embodiment, prevCtxState(Qp_prev) and prevCtxState(Qp_curr) are not calculated from the initValue as specified by the VVC standard as shown in Eqns. (12) and (13). Instead, prevCtxState(Qp_prev) is set to be the CABAC table CtxState(Qp_prev) for the previous slice to be inherited to the current slice, and is a known parameter. preCtxState(Qp_curr) is the CABAC table for the current slice, and can be obtained by converting CtxState (Qp_prev) with the quantization parameters QpY_prev and QpY_curr. From Eqns. (12) and (13),

$$preCtxState ( Qp\_curr ) = CtxState ( Qp\_prev ) * ( Clip 3 ( 1 , 127 , ( ( m\_curr * ( Clip 3 ( 0 , 63 , {Qp}_{Y \_ curr} ) - 16 ) ) ≫ 1 ) + n\_curr ) / Clip 3 ( 1 , 127 , ( ( m\_prev * ( Clip 3 ( 0 , 63 , {Qp}_{Y \_ prev} ) - 16 ) ) ≫ 1 ) + n\_prev ) ) \qquad ( 14 )$$

In some examples, Eqn. (14) can be executed only if the sliceTypes of the previous slice and the current slice are the same. If they are different, CABAC initialization value calculated by Eqn. (5) is applied.

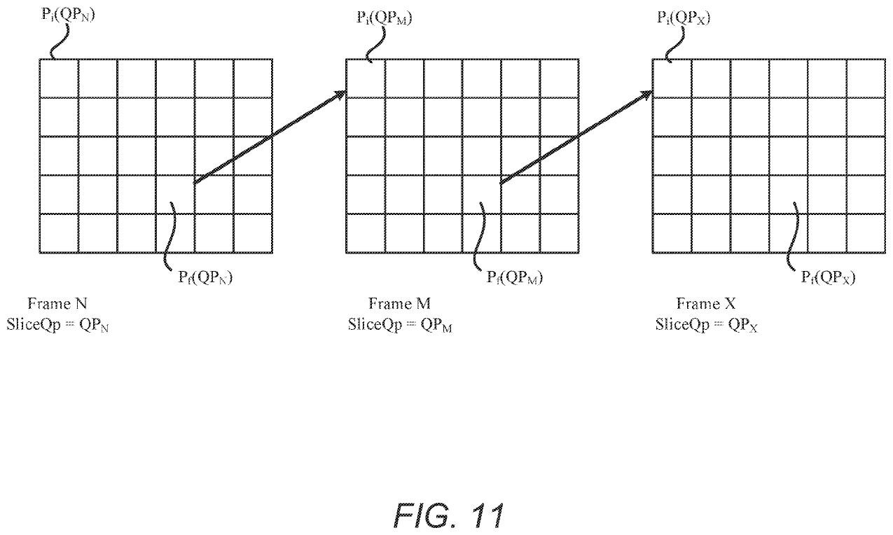

In another embodiment, the initial context value for the current slice is determined based on the QP values for the previous slice and the current slice as well as the initial context value and the inherited context value of the previous slice. FIG. 11 depicts an example of the various values involved in the context initialization table conversion of this embodiment.

As shown in FIG. 11, PᵢQP_{N} is the initial context value (e.g., p(1) in Eqn. (1)) for frame N with slice QP value QP_{N}. In other words, PᵢQP_{N} is the context value of the top-left CTU for frame N. P_{f}QP_{N} is the context value at a fixed location that is going to be inherited by the first CTU of slice M. The fixed location can be either the center CTU or the last CTU as discussed above. P_{f}QP_{N} is the initial context value for frame M with slice QP value QP_{M}, for the top-left CTU of frame M. P_{f}QP_{M} is the context value at the fixed location of either the center CTU or the last (bottom-right) CTU of frame M with QP_{M}. In other words, P_{f}QP_{M} is the context value that is going to be inherited by the first CTU of frame X. PᵢQP_{X} is the initial context value for frame X with Slice QP value QP_{X}, for the top-left CTU of frame X. P_{f}QP_{X} is the context value at the fixed location of either the center CTU or the last CTU of frame X with slice QP value SliceQP_{X}. In other words, this is the context value that is going to be inherited by the first CTU of the next frame after frame X.

In one example, the PᵢQP_{M} is derived as follows:

$${P}_{i} {QP}_{M} = {P}_{f} {QP}_{N} + ( ( {P}_{f} {QP}_{N} - {P}_{i} {QP}_{N} ) / {QP}_{N} ) * ( {QP}_{M} - {QP}_{N} ) \qquad ( 15 )$$

In another example, the initial context value can be derived as:

$${P}_{i} {QP}_{M} = PreCtxState ( {QP}_{M} ) + ( ( {P}_{f} {QP}_{N} - {P}_{i} {QP}_{N} ) / {QP}_{N} ) * {QP}_{M} ) . \qquad ( 16 )$$

$$Likewise ,$$

$${P}_{i} {QP}_{X} = PreCtxState ( {QP}_{X} ) + ( ( {P}_{f} {QP}_{M} - {P}_{i} {QP}_{M} ) / {QP}_{M} ) * {QP}_{X} ) . \qquad ( 17 )$$

The obtained result can be clipped to be within a certain range, such as [1,127]. PreCtxState(QP_{M}) and PreCtxState(QP_{X}) can be calculated based on Eqn. (5). If slice N is the first slice of the whole sequence, PᵢQP_{N} is the initial value PreCtxState(QP₀) defined by Eqn. (5) in the VVC standard, and P_{f}QP_{N} is the context value after encoding from the first CTU till the selected fixed CTU location for inheritance by slice M. If QP_{M} and QP_{N} are the same, then PᵢQP_{M} is set to P_{f}QP_{N}.

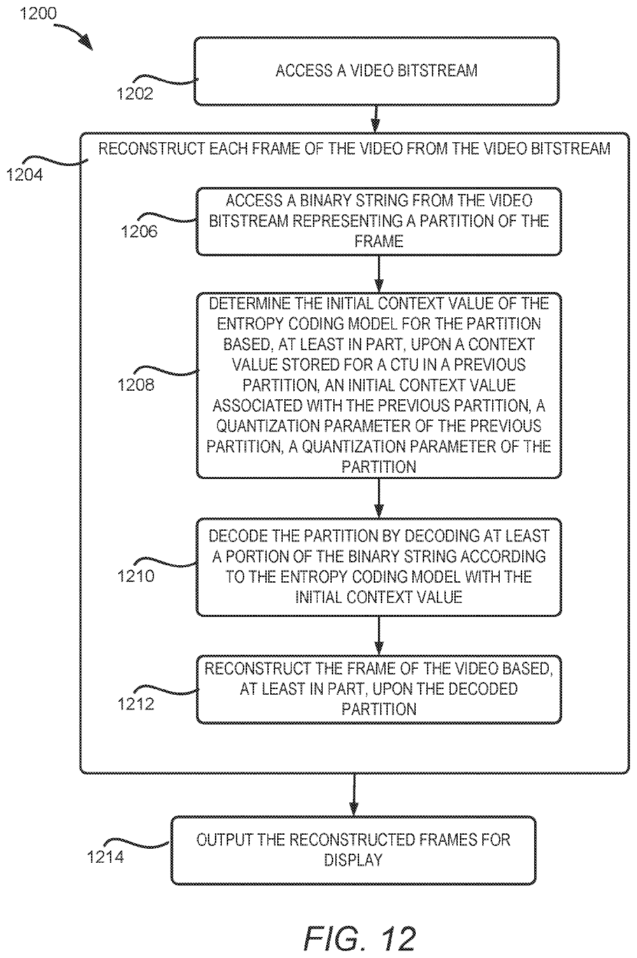

FIG. 12 depicts an example of a process 1200 for decoding a video encoded with the picture coding structure of random access via entropy coding with adaptive context initialization, according to some embodiments of the present disclosure. One or more computing devices (e.g., the computing device implementing the video decoder 200) implement operations depicted in FIG. 12 by executing suitable program code (e.g., the program code implementing the entropy decoding module 216). For illustrative purposes, the process 1200 is described with reference to some examples depicted in the figures. Other implementations, however, are possible.

At block 1202, the process 1200 involves accessing a video bitstream representing a video signal. The video bitstream is encoded by a video encoder using an entropy coding with the adaptive context initialization presented herein. At block 1204, which includes blocks 1206-1212, the process 1200 involves reconstructing each frame of the video from the video bitstream. At block 1206, the process 1200 involves accessing a binary bit string from the video bitstream that represents a partition of the frame, such as a slice. In some examples, the slice may be the entire frame. At block 1208, the process 1200 involves determining the initial context value (e.g., p(1) in Eqn. (1)) of an entropy coding model for the partition. The determination can be based on a context value stored for a CTU in a previous partition, an initial context value associated with the previous partition, the slice quantization parameter of the previous partition, and the slice quantization parameter of the partition.

As discussed above, in one example, the initial context value can be determined to be the context value of the previous frame in the coding order regardless of temporal layer and QP value as shown in the example of FIG. 9. In another example, the initial context value can be determined to be the context value of the previous frame in a lower temporal layer as shown in the example of FIG. 10. In a further example, the initial context value can be determined to be the context value of the reference frame(s) of the current frame according to the motion compensation and prediction structure. The context value of the previous frame can be the context value stored for a center CTU or the last CTU in the previous partition as discussed above.

For each of the examples above, the initial context value is inherited from a partition with a different slice QP value. Context initialization table convertion based on the previous slice QP value and the current slice QP value is utilized to convert the inherited initial context value to suit for the current partition with the current slice QP value. In one example, the conversion is performed according to Eqn. (15) based on the default initial context value determined using the quantization parameter of the previous partition and the default initial context value determined using the slice quantization parameter of the current partition. In another example, the conversion is performed based on the initial context value of the previous partition according to Eqn. (16). The initial context value of the previous partition can be determined using the same method described herein based on its previous partition.

At block 1210, the process 1200 involves decoding the partition by decoding the entropy coded portion of the binary string using the entropy coding model with the determined initial context value. The entropy decoded values may represent quantized and transformed residuals of the partition. At block 1212, the process 1200 involves reconstructing the frame based on the decoded partition. The reconstruction can include dequantization and inverse transformation of the entropy decoded values as described above with respect to FIG. 2 to reconstruct the pixel samples of the partition. If the frame has more than one partition, the operations in blocks 1206-1212 can be performed for other partition of the frame to reconstruct the frame. At block 1214, the reconstructed frames may also be output for displaying.

### CIPF Buffer Management

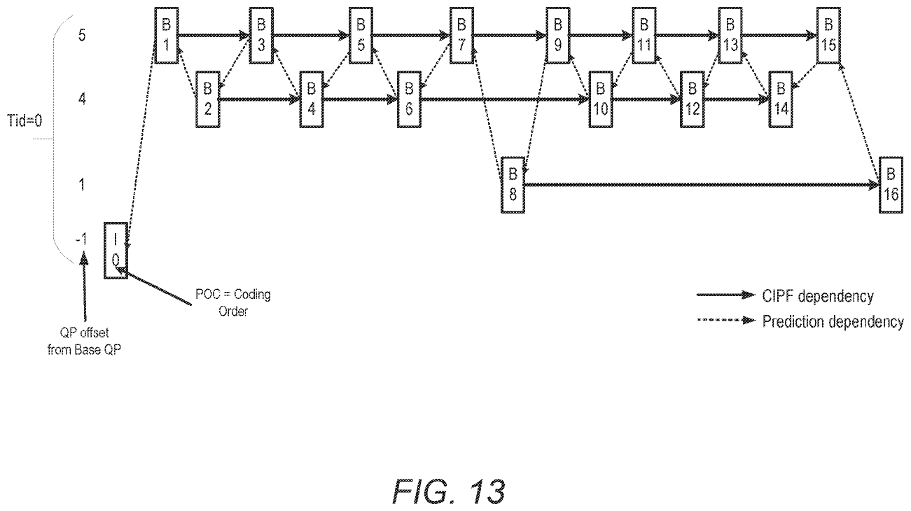

Under the current enhanced compression model (ECM) random access common test condition, the CIPF described with respect to FIG. 4 is applied as shown in FIG. 8. Under this test condition, the same slice QP value is assigned to slices in the same temporal layer. Under the ECM low delay (LD) common test condition (CTC), the CIPF described with respect to FIG. 4 is applied as shown in FIG. 13. Under this test condition, there is only one temporal layer, and within the temporal layer, multiple slice QP values are assigned.

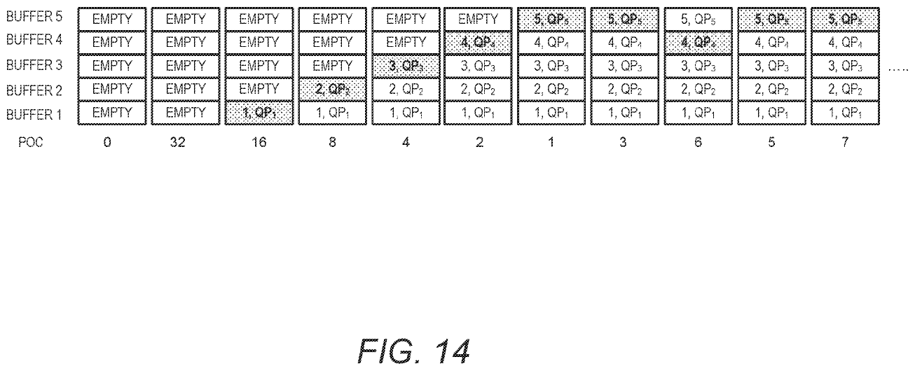

In the CIPF described with respect to FIG. 4, the total number of the context values stored in the buffers for CIPF is restricted to 5. FIG. 14 shows the behaviour of the CIPF buffer for the example shown in FIG. 8. In this example, QP₁ to QP₅ are defined as:

$${QP}_{1} = BaseQP + 0 \qquad ( 18 )$$

$${QP}_{2} = BaseQP + 1$$

$${QP}_{3} = BaseQP + 3$$

$${QP}_{4} = BaseQP + 5$$

$${QP}_{5} = BaseQP + 6$$

Here, QPᵢ is the QP value for the temporal layer with Tid=i. The five buffers are used to store the CABAC context values for corresponding QP values at the corresponding temporal layers. In other words, buffer i is used to store the CABAC context value for temporal layer i with quantization parameter QPᵢ. As such, the CABAC context table stored in the buffer is denoted as (Tid, QP) in FIG. 14. FIG. 14 shows the content of the buffer after the picture of POC shown at the bottom is coded. The shaded part indicates the new data stored in the buffer after the corresponding picture is coded.

After the pictures of POC 0 and POC 32 which are I frames are processed, the entire CIPF buffers, including buffer 1 to buffer 5, are empty and there is no need to store CABAC context values for inheritance. After the picture of POC 16, which is a B frame, is processed, the CABAC context value with QP₁ for Tid 1 is stored in the CIPF buffer 1. After the picture of POC 8 is processed, the CABAC context value with QP₂ for Tid 2 is stored in the CIPF buffer 2. After the picture of POC 4 is processed, the CABAC context value with QP₃ for Tid 3 is stored in the CIPF buffer 3. After the picture of POC 2 is processed, the CABAC context value with QP₄ for Tid 4 is stored in the CIPF buffer 4. After the picture of POC 1 is processed, the CABAC context value with QP₅ for Tid 5 is stored in the CIPF buffer 5.

In the process of encoding or decoding the picture of POC 3, the CABAC context value with QP₅ for Tid 5 is used because POC 3 has Tid 5 and QP₅. This CABAC context value is stored in the CIPF buffer 5 after encoding the picture of POC 1. The CABAC context value with QP₅ for Tid 5 in the CIPF buffer 5 is thus updated after the picture of POC 3 is processed.

In the process of encoding or decoding the picture of POC 6, the CABAC context value with QP₄ for Tid 4, which is stored in the CIPF buffer 4 after encoding the picture of POC 2, is used. The CABAC context value with QP₄ for Tid 4 in the CIPF buffer 4 is updated after the picture of POC 6 is processed.

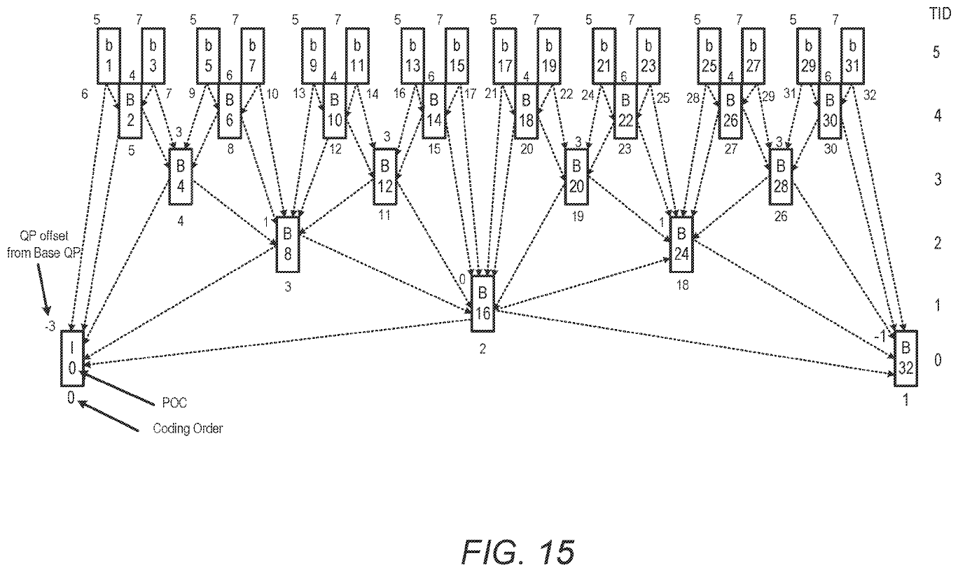

In real world video encoder, the rate control and quantization control for perceptual optimization are usually employed. With the rate control and quantization control, the SliceQPs can be different even in the same temporal layer. FIG. 15 shows another example of the RA test condition. In this example, the GOP structure is the same as the example shown in FIG. 8. But for the temporal layers 4 and 5, QP values are not constant.

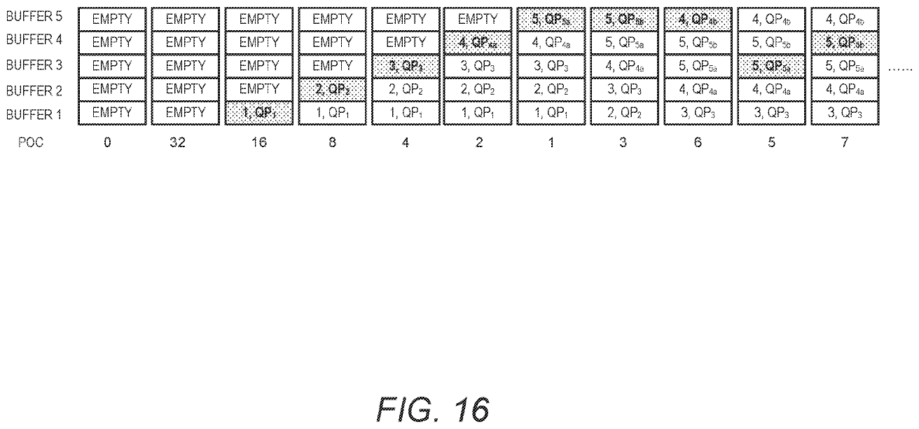

The behaviour of the CIPF buffer for the example of FIG. 15 is shown in FIG. 16. In this example, QP₁ to QP_{5b} are defined as:

$${QP}_{1} = BaseQP + 0 [ Tid : 1 ] \qquad ( 19 )$$

$${QP}_{2} = BaseQP + 1 [ Tid : 2 ]$$

$${QP}_{3} = BaseQP + 3 [ Tid : 3 ]$$

$${QP}_{4 a} = BaseQP + 4 [ Tid : 4 ]$$

$${QP}_{4 b} = BaseQP + 6 [ Tid : 4 ]$$

$${QP}_{5 a} = BaseQP + 5 [ Tid : 5 ]$$

$${QP}_{5 b} = BaseQP + 7 [ Tid : 5 ]$$

Here, both QP₄ₐ and QP_{4b} can be used for temporal layer 4 and both QP₅ₐ and QP_{5b} can be used for temporal layer 5. After the pictures of POC 0 and POC 32 are processed, the entire CIPF buffer is empty and thus there is no need to store CABAC context tables for inheritance. After the picture of POC 16 is processed, the CABAC context value with QP₁ for Tid 1 is stored in the CIPF buffer 1. After the picture of POC 8 is processed, the CABAC context value with QP₂ for Tid 2 is stored in the CIPF buffer 2. After the picture of POC 4 is processed, the CABAC context value with QP₃ for Tid 3 is stored in the CIPF buffer 3. After the picture of POC 2 is processed, the CABAC context value with QP₄ₐ for Tid 4 is stored in the CIPF buffer 4. After the picture of POC 1 is processed, the CABAC context value with QP₅ₐ for Tid 5 is stored in the CIPF buffer 5.

In the process of encoding or decoding the picture of POC 3, the CABAC initialization value with QP_{5b} calculated using Eqn. (6) is used. Since QP_{5b} for Tid 5 is new to the CIPF buffer, the context values with QP₅ₐ for Tid 5, QP₄ₐ for Tid 4, QP₃ for Tid 3, QP₂ for Tid 2 are moved to the CIPF buffer 4, 3, 2, 1 respectively. Then the CABAC context value with QP_{5b} for Tid 5 is loaded to the CIPF buffer 5 after the picture of POC 3 is processed. As a result, the context value with QP₁ for Tid 1 is removed from the buffer.

In the process of encoding or decoding of the picture of POC 6, the CABAC initialization value with QP_{4b} calculated using Eqn. (5) is used. Since QP_{4b} for Tid 4 is new to the CIPF buffer, the context values with QP_{5b} for Tid 5, QP₅ₐ for Tid 5, QP₄ₐ for Tid 4, QP₃ for Tid 3 are moved to the CIPF buffer 4, 3, 2, 1 respectively. Then the CABAC context value with QP_{4b} for Tid 4 is added to the CIPF buffer 5 after the picture of POC 6 is processed. As a result, the context value with QP₂ for Tid 2 is removed from the buffer. As seen in the above description, the CABAC initialization value calculated using Eqn. (5) rather than the CIPF have been used in the coding of the pictures from POC 0 through POC 6.

In the process of encoding or decoding the picture of POC 24, CIPF cannot be applied either, because the CABAC context table with QP₂ for Tid 2 does not exist in the CIPF buffer. Usually, a smaller QP value is applied to the pictures in the lower temporal layers, and a bigger QP value is applied to the pictures in the higher temporal layers, because the picture quality of the lower temporal layers affects the picture quality of pictures at the higher temporal layers. As a result, more bits are spent for the pictures in the lower temporal layers and fewer bits are spent for the pictures in the higher temporal layers. Bit saving of the pictures achieved in the encodings at the lower temporal layer is more important to improve overall coding efficiency. Therefore, in this example, the fact that CABAC context table initialization cannot be applied to Tid 2 significantly reduces the coding efficiency improvement that would have been achieved by CIPF.

To solve this problem, the number of buffers can be increased in some cases to accommodate the different combinations of the temporal layer and quantization parameter. For example, the number of buffers can be set to to be max (5, maximum number of sublayers −1), instead of 5. In this way, the buffers can handle the cases in FIGS. 8 and 13. For example, the proposed buffer configuration allows multiple CIPF buffers be allocated to the single Tid if the value of max sublayers (temporal layers)−1 is 0, that is, only one temporal layer is contained in the bitstream. The allocated multiple CIPF buffers can support the condition like LD CTC shown in FIG. 13.

In another example, the number of CIPF buffers can be set equal to the number of hierarchical layers in the motion compensation and prediction structure. Inheriting the CABAC context value for a current slice can use the context value in the buffer which has the same Tid. The inheritance is also allowed even if the QP values of the previous and the current slices are different. The discrepancy between the different QP values can be addressed by converting the CABAC context values associated with the QP values of the previous frame and the current frame.

In one example, the conversion can be performed using the Eqns. (16) and (17), or more generally,

$${P}_{i} QP ( N + 1 ) = PreCtxState ( QP ( N + 1 ) ) + ( ( {P}_{f} QP ( N ) - PreCtxState ( QP ( N ) ) ) / QP ( N ) ) * QP ( N + 1 ) \qquad ( 20 )$$

In another example, the conversion can be performed as:

$$When QP ( N + 1 ) \neq QP ( N ) , \qquad ( 21 )$$

$${P}_{i} QP ( N + 1 ) = PreCtxState ( QP ( N + 1 ) ) + ( ( {P}_{f} QP ( N ) - {P}_{i} QP ( N ) ) ) / QP ( N ) ) * QP ( N + 1 )$$

$$Otherwise ( i . e . , QP ( N + 1 ) = QP ( N ) ) ,$$

$${P}_{i} QP ( N + 1 ) = {P}_{f} QP ( N ) ;$$

It is noted that the QP(N) is in the range of 0 and 63. If the QP value SliceQP for a particular frame is outside this range, the SliceQP should be first clipped accordingly before it is applied to (20) or (21). As an example, the clipping function can be defined as:

$$QP ( N ) = Clip 3 ( 0 , 63 , SliceQP ( N ) ) \qquad ( 22 )$$

where QP(N)=SliceQP(N) when 0<=SliceQP(N)<=63; QP(N)=0, when SliceQP(N)<0; and QP(N)=63, when SliceQP(N)>63.

In addition, for Eqns. (20) and (21), if QP(N) and QP(N+1) are equal to 0, the context model P_{f}QP(N) of frame N should be used directly as the initial value PᵢQP(N+1) for frame N+1. If QP(N) is equal to 0 and QP(N+1) is not equal to 0, the CABAC context initialization value calculated using equations (5) is applied.

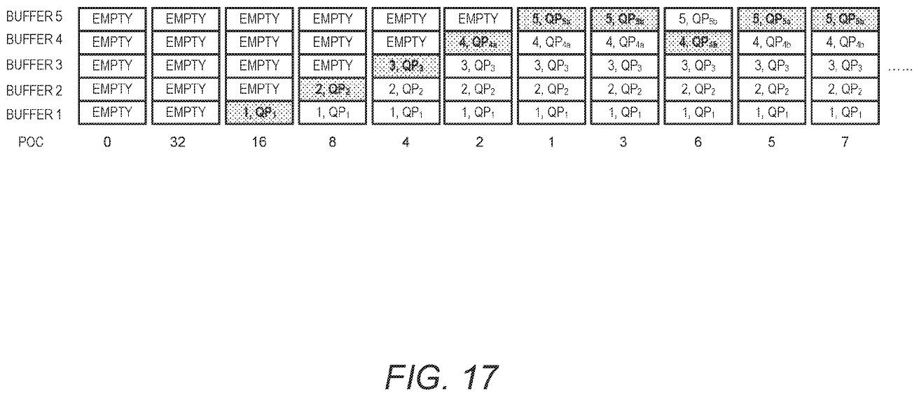

FIG. 17 shows an example of the behaviour of the proposed CIPF buffer configuration for the RA test condition shown in FIG. 15, according to some embodiments of the present disclosure. In this example, QP₁ to QP_{5b} are defined by Eqn. (19). After the I pictures of POC 0 and POC 32 are processed, the entire CIPF buffer is empty, because there is no need to store CABAC context values for inheritance. After the picture of POC 16 is processed, the CABAC context value with QP₁ for Tid 1 is stored in the CIPF buffer 1. After the picture of POC 8 is processed, the CABAC context value with QP₂ for Tid 2 is stored in the CIPF buffer 2. After the picture of POC 4 is processed, the CABAC context value with QP₃ for Tid 3 is stored in the CIPF buffer 3. After the picture of POC 2 is processed, the CABAC context value with QP₄ₐ for Tid 4 is stored in the CIPF buffer 4. After the picture of POC 1 is processed, the CABAC context value with QP₅ₐ for Tid 5 is stored in the CIPF buffer 5.

In the encoding or decoding of the picture of POC 3 which has a different QP value from the picture of POC 1, a converted CABAC context value is first calculated. The conversion can be performed using the CABAC context value in the CIPF buffer 5, the previous slice QP value QP₅ₐ and the current slice QP value QP_{5b} according to Eqn. (10) or (11). The converted CABAC context value is applied in the encoding or decoding process. After the encoding or the decoding of the picture POC 3, the CABAC context value at a selected location in the picture of POC 3 (e.g., the CTU location selected based on Eqn. (8) or (11)) is stored in the CIPF buffer 5.

In the encoding or the decoding of the picture of POC 6 which has a different QP value than the picture of POC 2, a converted CABAC context value is first calculated. The calculation can be performed using the CABAC context value in the CIPF buffer 4, the previous slice QP value QP₄ₐ and the current slice QP value QP_{4b} according to Eqn. (10) or (11). The converted CABAC context value is applied in the encoding or decoding process. After the encoding or the decoding of the picture of POC 6, the CABAC context value at a selected location in the picture of POC 6 (e.g., the CTU location selected based on Eqn. (8) or (11)) is stored in the CIPF buffer 4. In contrast to FIG. 16 where CIPF cannot be applied to POC 0 to POC 6, the CABAC initialization values calculated by Eqn. (20) or (21) can be used in the coding of at least these pictures. Further, the CIPF can also be applied to the picture of POC 24, as the CABAC context Table with QP₂ for Tid 2 is maintained in the CIPF buffer and is available for the coding of picture of POC 24.

With the proposed CIPF buffer management, the CIPF buffers always keep a set of CABAC context values from each temporal layer. As a result, the CIPF process can be applied to each eligible picture by using the CABAC context value stored in the buffer that has the same temporal layer index. After coding the current picture, the new CABAC context value will replace the existing CABAC context value in the buffer that has been used as the initial CABAC context value and has the same temporal layer index as the current picture.

With the proposed CIPF buffer management, the CIPF proposed in Eqn. (10) or (11) can be applied. Alternatively, the existing CABAC context value inheritance approach (i.e., inheritance from a previous frame with the same slice QP value in the same temporal layer) can also be applied with an exception. When the slice QP value of the current picture is different from the QP value of the CABAC context value in the buffer that has the same temporal layer index, the default initialization value calculated using Eqn. (5) is applied instead.

Likewise, the buffer management shown in FIG. 16 can be improved by applying the default context initilization in Eqn. (5) when the slice QP value of a current picture is different from the slice QP value stored in the buffer for the same temporal layer. In this way, the CABAC context values for the lower temporal layers are not discarded and will be available for CIPF when coding the pictures in the lower temporal layers.

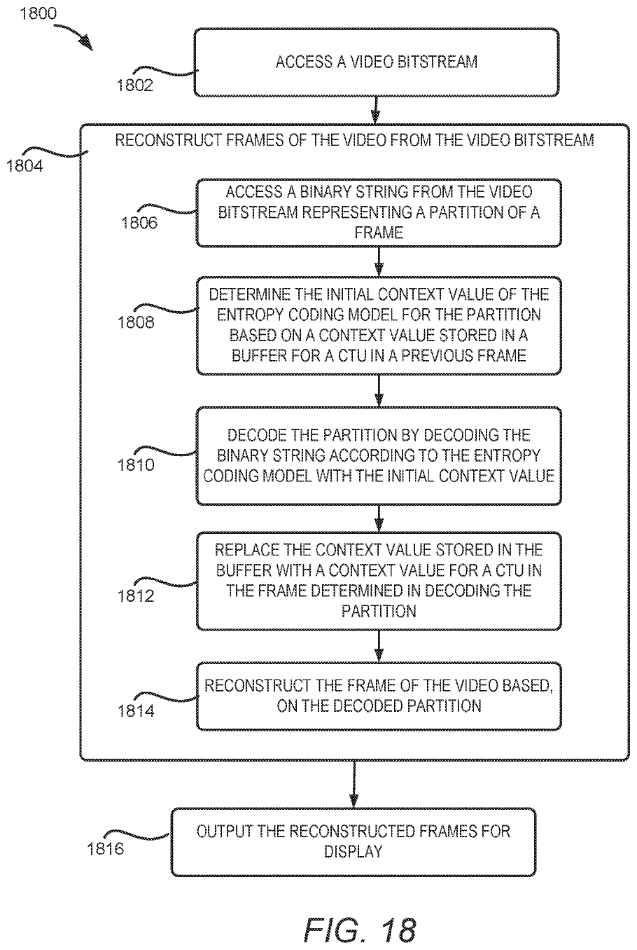

FIG. 18 depicts an example of a process 1800 for decoding a video encoded with the picture coding structure of random access via entropy coding with adaptive context initialization, according to some embodiments of the present disclosure. One or more computing devices (e.g., the computing device implementing the video decoder 200) implement operations depicted in FIG. 18 by executing suitable program code (e.g., the program code implementing the entropy decoding module 216). For illustrative purposes, the process 1800 is described with reference to some examples depicted in the figures. Other implementations, however, are possible.

At block 1802, the process 1800 involves accessing a video bitstream representing a video signal. The video bitstream is encoded by a video encoder using an entropy coding with the adaptive context initialization presented herein. At block 1804, which includes blocks 1806-1814, the process 1800 involves reconstructing each frame of the video from the video bitstream. At block 1806, the process 1800 involves accessing a binary bit string from the video bitstream that represents a partition of a frame, such as a slice. In some examples, the slice may be the entire frame. At block 1808, the process 1800 involves determining the initial context value (e.g., PᵢQP(N+1) in Eqns. (20) and (21)) of an entropy coding model for the partition. The decoder can access a buffer, from a set of buffers, that corresponds to the temporal layer (i.e., sublayer) of the frame to obtain the context value stored for a CTU in the previous frame (e.g., P_{f}QP(N) in Eqns. (20) and (21). As discussed above, the stored context value may be for a center CTU or the last CTU in the previous frame.

As discussed above, in one embodiment, the number of buffers is set to the number of temporal layers, each temporal layer having one buffer storing the context value. It is likely that the slice quantization parameters for the frames in the same temporal layer have different values. As such, the same buffer will need to store the context values for frames with different parameter values. When the frame has a slice quantization parameter different from that of the previous frame, context value retrieved from the buffer can be to be converted before being used to derive the initial context value for the current frame. For example, the conversion can be performed according to Eqn. (20) or (21). In another embodiment, the number of buffers can be set to the larger value of 5 and the number of maximum sub-layers in the video. In this way, one buffer is used to store data for one combination of the temporal layer index and the slice quantization parameter value. No conversion is needed in this embodiment so long as the combination of the temporal layer index and the slice quantization parameter is in the CIPF buffer.

At block 1810, the process 1800 involves decoding the partition by decoding the entropy coded portion of the binary string using the entropy coding model with the determined initial context value. The entropy decoded values may represent quantized and transformed residuals of the partition. At block 1812, the process 1800 involves replacing the context value stored in the buffer with the context value determined for a CTU in the frame during the decoding. As discussed above, the CTU may be the center CTU or the last CTU of a slice in the frame depending on the value of the syntax elements indicating the location of the CTU for CIPF, such as sps_cipf_center_flag.

At block 1814, the process 1800 involves reconstructing the frame based on the decoded partition. The reconstruction can include dequantization and inverse transformation of the entropy decoded values as described above with respect to FIG. 2 to reconstruct the pixel samples of the partition. If the frame has more than one partition, the operations in blocks 1806-1814 can be performed for other partition of the frame to reconstruct the frame. At block 1816, the reconstructed frames may be output for displaying.

### Computing System Example

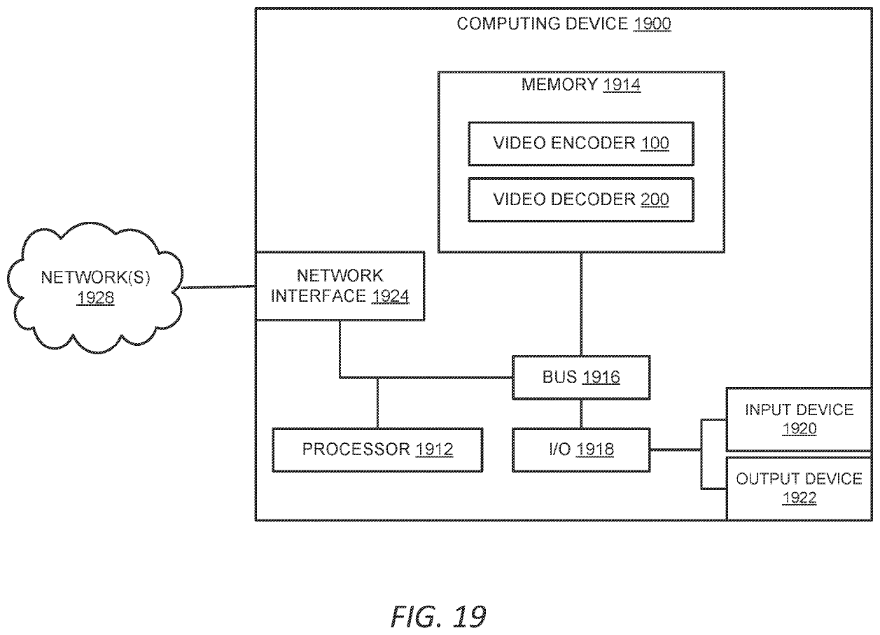

Any suitable computing system can be used for performing the operations described herein. For example, FIG. 19 depicts an example of a computing device 1900 that can implement the video encoder 100 of FIG. 1 or the video decoder 200 of FIG. 2. In some embodiments, the computing device 1900 can include a processor 1912 that is communicatively coupled to a memory 1914 and that executes computer-executable program code and/or accesses information stored in the memory 1914. The processor 1912 may comprise a microprocessor, an application-specific integrated circuit (“ASIC”), a state machine, or other processing device. The processor 1912 can include any of a number of processing devices, including one. Such a processor can include or may be in communication with a computer-readable medium storing instructions that, when executed by the processor 1912, cause the processor to perform the operations described herein.

The memory 1914 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 1900 can also include a bus 1916. The bus 1916 can communicatively couple one or more components of the computing device 1900. The computing device 1900 can also include a number of external or internal devices such as input or output devices. For example, the computing device 1900 is shown with an input/output (“I/O”) interface 1918 that can receive input from one or more input devices 1920 or provide output to one or more output devices 1922. The one or more input devices 1920 and one or more output devices 1922 can be communicatively coupled to the I/O interface 1918. The communicative coupling can be implemented via any suitable manner (e.g., a connection via a printed circuit board, connection via a cable, communication via wireless transmissions, etc.). Non-limiting examples of input devices 1920 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1922 include an LCD screen, an external monitor, a speaker, or any other device that can be used to display or otherwise present outputs generated by a computing device.

The computing device 1900 can execute program code that configures the processor 1912 to perform one or more of the operations described above with respect to FIGS. 1-18. The program code can include the video encoder 100 or the video decoder 200. The program code may be resident in the memory 1914 or any suitable computer-readable medium and may be executed by the processor 1912 or any other suitable processor.

The computing device 1900 can also include at least one network interface device 1924. The network interface device 1924 can include any device or group of devices suitable for establishing a wired or wireless data connection to one or more data networks 1928. Non-limiting examples of the network interface device 1924 include an Ethernet network adapter, a modem, and/or the like. The computing device 1900 can transmit messages as electronic or optical signals via the network interface device 1924.

### General Considerations

Numerous details are set forth herein to provide a thorough understanding of the claimed subject matter. However, those skilled in the art will understand that the claimed subject matter may be practiced without these details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Some blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method for decoding a video from a video bitstream representing the video, the method comprising:
accessing a binary string from the video bitstream, the binary string representing a slice of a frame of the video;
determining an initial context value of an entropy coding model for the slice to be one of a first context value stored for a first CTU in a previous slice of the slice, a second context value stored for a second CTU in the previous slice, and a default initial context value independent of the previous slice;
decoding the slice by decoding at least a portion of the binary string according to the entropy coding model with the initial context value;
reconstructing the frame of the video based, at least in part, upon the decoded slice; and
causing the reconstructed frame to be displayed along with other frames of the video.

2. The method of claim 1, wherein CTUs in the previous slice are encoded according to an encoding order and the first CTU is encoded before the second CTU in the previous slice.

3. The method of claim 2, wherein a location of the first CTU is determined by:
$$CTU location = min ( ( W + C ) / 2 + 1 , C )$$
where W is a number of CTUs in a CTU row of the previous slice, and C is a total number of CTUs in the previous slice; and the second CTU is a last CTU in the previous slice.

4. The method of claim 1, wherein determining the initial context value comprises:
extracting, from the video bitstream, a syntax element indicating a CTU location for obtaining the initial context value from the previous slice;
in response to determining that the syntax element has a first value, determining the initial context value to be the first context value stored for the first CTU; and
in response to determining that the syntax element has a second value, determining the initial context value to be the second context value stored for the second CTU.

5. The method of claim 4, wherein determining the initial context value further comprises:
extracting, from the video bitstream, a second syntax element indicating whether to use the initial context value from the previous slice, wherein extracting the syntax element indicating the CTU location for obtaining the initial context value from the previous slice is performed in response to determining that the second syntax element has a first value, and
in response to determining that the second syntax element has a second value, determining the initial context value to be the default initial context value;
wherein the syntax element and the second syntax element are extracted from a picture header of the frame or a slice header of the slice.

6. The method of claim 1, wherein determining the initial context value comprises:
extracting, from the video bitstream, a syntax element indicating a threshold value for determining a CTU location for obtaining the initial context value from the previous slice;
comparing a quantization parameter (QP) value of the previous slice with the threshold value;
in response to determining that the QP value is no higher than the threshold value, determining the initial context value to be the first context value stored for the first CTU; and
in response to determining that the QP value is higher than the threshold value, determining the initial context value to be the second context value stored for the second CTU.

7. The method of claim 1, wherein determining the initial context value comprises:
extracting, from the video bitstream, a first syntax element indicating a first threshold value for determining whether to use the initial context value from the previous slice and a second syntax element indicating a second threshold value for determining a CTU location for obtaining the initial context value from the previous slice, the second threshold value is no higher than the first threshold value;
comparing a temporal layer index of the slice with the first threshold value;
in response to determining that the temporal layer index is higher than the first threshold value, determining the initial context value to be the default initial context value;
in response to determining that the temporal layer index is no higher than the first threshold value, comparing the temporal layer index of the slice with the second threshold value;
in response to determining that the temporal layer index is no higher than the second threshold value, determining the initial context value to be the first context value stored for the first CTU; and
in response to determining that the temporal layer index is higher than the second threshold value, determining the initial context value to be the second context value stored for the second CTU.

8.-20. (canceled)

21. A method for decoding a video from a video bitstream representing the video, the method comprising:
accessing a binary string from the video bitstream, the binary string representing a partition of the video;
determining an initial context value of an entropy coding model for the partition by converting a context value stored for a CTU in a previous partition of the partition based on an initial context value associated with the previous partition, a slice quantization parameter of the previous partition, and a slice quantization parameter of the partition;
decoding the partition by decoding at least a portion of the binary string according to the entropy coding model with the initial context value;
reconstructing frames of the video based, at least in part, upon the decoded partition; and
causing the reconstructed frames to be displayed.

22. The method of claim 21, wherein the context value stored for a CTU in the previous partition comprises a first context value stored for a center CTU in a decoding order in a previous partition, or a second context value stored for a last CTU in the decoding order in the previous partition.

23. The method of claim 21, wherein the initial context value associated with the previous partition comprises a default initial context value determined based, at least in part, upon the slice quantization parameter of the previous partition or an initial context value determined based, at least in part, upon a context value stored for a CTU in a previous partition of the previous partition.

24. The method of claim 21, wherein the partition is a frame, and the previous partition is a frame proceeding the frame according to a coding order of the video.

25. The method of claim 21, wherein the partition is a frame, and the previous partition is a closest frame in a temporal layer below the frame that is coded before the frame.

26. The method of claim 21, wherein the partition is a frame, and the previous partition is a reference frame of the frame according to motion compensation information of the video, wherein determining the initial context value of the entropy coding model for the partition is performed further based on a second context value stored for a second CTU in a second previous partition of the partition, and wherein the second previous partition is a second reference frame of the frame according to the motion compensation information of the video.

27.-40. (canceled)

41. A method for decoding a video from a video bitstream representing the video, the method comprising:
accessing a binary string from the video bitstream, the binary string representing a partition of a frame of the video;
determining an initial context value for an entropy coding model for the partition by converting a context value stored in a buffer for a CTU in a previous frame of the frame based on an initial context value associated with the previous frame, a slice quantization parameter of the previous frame, and a slice quantization parameter of the frame;
decoding the partition by decoding at least a portion of the binary string according to the entropy coding model with the initial context value;
replacing the context value stored in the buffer with a context value for a CTU in the frame determined in decoding the partition;
reconstructing the frame of the video based, at least in part, upon the decoded partition; and
causing the reconstructed frame to be displayed.

42. The method of claim 41, wherein the context value stored for a CTU in the previous frame comprises a first context value stored for a center CTU in a decoding order in a partition of the previous frame, or a second context value stored for a last CTU in the decoding order in the partition of the previous frame.

43. The method of claim 41, wherein the initial context value associated with the previous frame comprises a default initial context value determined based, at least in part, upon the slice quantization parameter of the previous frame.

44. The method of claim 41, wherein the initial context value associated with the previous frame comprises an initial context value determined based, at least in part, upon a context probability stored for a CTU in a previous frame of the previous frame, wherein determining the initial context value for the entropy coding model for the partition comprises, in response to determining that the slice quantization parameter of the frame is the same as the slice quantization parameter of the previous frame, determining the initial context value to be the context value stored in the buffer, wherein the converting is performed in response to determining that the slice quantization parameter of the frame is different from the slice quantization parameter of the previous frame.

45. The method of claim 41, wherein the buffer is identified based on a temporal layer index of the frame.

46. The method of claim 45, wherein the buffer is one of a plurality of buffers, each buffer of the plurality of buffers configured to store a context value for a frame in a corresponding temporal layer of a plurality of temporal layers.

47. The method of claim 46, wherein a number of buffers in the plurality of buffers is determined as a larger value between 5 and max_sublayers_minus1 specified in a video parameter set (VPS) or a sequence parameter set (SPS), wherein max_sublayers_minus1 represents a maximum number of temporal layers for the video.

48.-60. (canceled)
